(19) United States
(12) Patent Application Publication
(10) Pub. No.: US 2024/0356043 A1
(43) Pub. Date: Oct. 24, 2024

(54) ENERGY STORAGE DEVICE, METHOD FOR MANUFACTURING ENERGY STORAGE DEVICE, AND ENERGY STORAGE APPARATUS

(71) Applicant: GS Yuasa International Ltd., Kyoto-shi, Kyoto (JP)

(72) Inventors: Yuya ITAMI, Kyoto (JP); Hideto WATANABE, Kyoto (JP); Hiromasa MURAMATSU, Kyoto (JP); Heisuke NISHIKAWA, Kyoto (JP)

(21) Appl. No.: 18/693,359

(22) PCT Filed: Sep. 21, 2022
(86) PCT No.: PCT/JP2022/035198

§ 371 Date: Mar. 19, 2024

(30) Foreign Application Priority Data
Sep. 22, 2021 (JP) 2021-154898

(51) Int. Cl. H01M 4/62; H01G 11/26; H01G 11/30; H01G 11/52; H01G 11/74; H01G 11/86; H01M 4/02; H01M 4/134; H01M 10/0587

(52) U.S. Cl. CPC H01M 4/628; H01G 11/26; H01G 11/30; H01G 11/52; H01G 11/74; H01G 11/86; H01M 4/134; H01M 10/0587; H01M 2004/027

(57) ABSTRACT

An energy storage device according to one aspect of the present invention includes: an electrode assembly including a positive electrode, a negative electrode, and a separator; and a nonaqueous electrolyte, in which the negative electrode includes: a negative substrate; a first layer disposed directly or indirectly on the separator side of the negative substrate and containing a metal of gold, platinum, or a combination thereof; and a second layer disposed on the separator side of the first layer, containing a polymer having lithium ion conductivity and a lithium salt, and capable of regulating passage of the nonaqueous electrolyte, and the negative electrode further includes a lithium metal layer disposed between the negative substrate and the first layer.

### TECHNICAL FIELD

The present invention relates to an energy storage device, a method for manufacturing an energy storage device, and an energy storage apparatus.

### BACKGROUND ART

Nonaqueous electrolyte secondary batteries typified by lithium ion secondary batteries are often used for electronic devices such as personal computers and communication terminals, motor vehicles, and the like since, because the batteries are high in energy density. The nonaqueous electrolyte secondary battery generally includes a pair of electrodes electrically isolated from each other by a separator, and a nonaqueous electrolyte interposed between the electrodes, and is configured to allow charge transport ions to be transferred between both the electrodes for charge-discharge. In addition, capacitors such as lithium ion capacitors and electric double-layer capacitors are also widely in use as energy storage devices except for the nonaqueous electrolyte secondary batteries.

In recent years, in order to increase the capacity of nonaqueous electrolyte secondary batteries, it has been required to increase the capacity of the negative electrode. Lithium metal has a significantly larger theoretical capacity per active material mass than graphite, which is currently widely used as a negative active material for lithium ion secondary batteries. That is, the theoretical capacity per mass of graphite is 372 mAh/g, but the theoretical capacity per mass of lithium metal is 3860 mAh/g, which is significantly large. Thus, a nonaqueous electrolyte secondary battery containing lithium metal as a negative active material has been proposed (see Patent Document 1).

### PRIOR ART DOCUMENT

### Patent Document

Patent Document 1: JP-A-2011-124154

### SUMMARY OF THE INVENTION

### Problems to be Solved by the Invention

In an energy storage device in which lithium metal is used for the negative active material as described above, lithium metal may be precipitated in a dendritic form at a negative electrode surface during charge (hereinafter, lithium metal in a dendritic form is referred to as a “dendrite”). When the dendrite grows toward the separator side, the dendrite penetrates the separator and comes into contact with a positive electrode, which may cause a short circuit or the like.

An object of the present invention is to provide an energy storage device in which growth of dendrite toward a separator side is suppressed, a method for manufacturing the energy storage device, and an energy storage apparatus including the energy storage device.

### Means for Solving the Problems

An energy storage device according to one aspect of the present invention includes: an electrode assembly including a positive electrode, a negative electrode, and a separator; and a nonaqueous electrolyte, in which the negative electrode includes: a negative substrate; a first layer disposed directly or indirectly on the separator side of the negative substrate and containing a metal of gold, platinum, or a combination thereof; and a second layer disposed on the separator side of the first layer, containing a polymer having lithium ion conductivity and a lithium salt, and capable of regulating passage of the nonaqueous electrolyte, and the negative electrode further includes a lithium metal layer disposed between the negative substrate and the first layer.

A method for manufacturing an energy storage device according to another aspect of the present invention includes: preparing a positive electrode; preparing a separator; preparing a negative electrode; and producing an electrode assembly by stacking the positive electrode, the separator, and the negative electrode such that the positive electrode, the separator, and the negative electrode are arranged in this order, in which the preparing the negative electrode includes: forming a first layer containing a metal of gold, platinum, or a combination thereof directly or indirectly on the separator side of a negative substrate; forming a second layer containing a polymer having lithium ion conductivity and a lithium salt and capable of restricting passage of the nonaqueous electrolyte on the separator side of the first layer; and forming a lithium metal layer between the negative substrate and the first layer.

An energy storage apparatus according to another aspect of the present invention includes: the one or a plurality of energy storage devices; and a restraining member that restrains the one or the plurality of energy storage devices, in which the one or the plurality of energy storage devices are pressed in a thickness direction by the binding by the binding member, whereby the electrode assembly is pressed.

### Advantages of the Invention

In the energy storage device according to one aspect of the present invention, the growth of dendrite toward the separator side is suppressed.

In the method for manufacturing an energy storage device according to another aspect of the present invention, it is possible to manufacture an energy storage device in which the growth of dendrite toward the separator side is suppressed.

In the energy storage apparatus according to another aspect of the present invention, the growth of dendrite in the energy storage device toward the separator side is suppressed.

### BRIEF DESCRIPTION OF THE DRAWINGS

FIG. 1 is a side sectional view schematically illustrating a layer configuration of an electrode assembly of one embodiment of an energy storage device.

FIG. 2 is a side sectional view schematically illustrating a layer configuration of an electrode assembly of another embodiment of the energy storage device.

FIG. 3 is a see-through perspective view illustrating one embodiment of the energy storage device.

FIG. 4 is a schematic diagram illustrating one embodiment of an energy storage apparatus including a plurality of the energy storage devices assembled.

FIG. 5 is an FE-SEM image showing a crystal shape of lithium metal deposited on a first layer containing gold in a negative electrode.

FIG. 6 is an FE-SEM image showing a crystal shape of lithium metal deposited on a second lithium metal layer in the negative electrode not including the first layer.

### MODE FOR CARRYING OUT THE INVENTION

First, outlines of an energy storage device, a method for manufacturing the energy storage device, and an energy storage apparatus disclosed in the present specification will be described.

### Item 1.

An energy storage device according to one embodiment of the present invention includes: an electrode assembly including a positive electrode, a negative electrode, and a separator; and a nonaqueous electrolyte, in which the negative electrode includes: a negative substrate; a first layer disposed directly or indirectly on the separator side of the negative substrate and containing a metal of gold, platinum, or a combination thereof; and a second layer disposed on the separator side of the first layer, containing a polymer having lithium ion conductivity and a lithium salt, and capable of regulating passage of the nonaqueous electrolyte, and the negative electrode further includes a lithium metal layer disposed between the negative substrate and the first layer.

According to the energy storage device according to item 1, it is possible to suppress growth of dendrite in the energy storage device toward the separator side.

### Item 2.

In the energy storage device according to item 1, the polymer contained in the second layer may include a polymer material containing vinylene carbonate, acrylonitrile, or a combination thereof as a monomer.

According to the energy storage device according to item 2, it is possible to suppress the growth of dendrite in the energy storage device toward the separator side.

### Item 3.

In the energy storage device according to item 1 or 2, the negative electrode may further include a lithium metal layer disposed between the first layer and the separator.

According to the energy storage device according to item 3, it is possible to suppress the growth of dendrite in the energy storage device toward the separator side.

### Item 4.

In the energy storage device according to any one of items 1 to 3, the separator may include a substrate layer and an inorganic material layer disposed on the negative electrode side of the substrate layer.

According to the energy storage device according to item 4, it is possible to suppress the growth of dendrite in the energy storage device toward the separator side.

### Item 5.

In the energy storage device according to any one of items 1 to 4, the lithium salt may be lithium difluorophosphate, lithium difluoro(oxalato)borate, lithium bis(trifluoromethanesulfonyl)imide, or a combination thereof.

According to the energy storage device according to item 5, it is possible to suppress the growth of dendrite in the energy storage device toward the separator side.

### Item 6.

The energy storage device according to any one of items 1 to 5 may be in a state where the electrode assembly is pressed in a thickness direction thereof.

According to the energy storage device according to item 6, it is possible to suppress the growth of dendrite in the energy storage device toward the separator side.

### Item 7.

A method for manufacturing an energy storage device according to one embodiment of the present invention includes: preparing a positive electrode; preparing a separator; preparing a negative electrode; and producing an electrode assembly by stacking the positive electrode, the separator, and the negative electrode such that the positive electrode, the separator, and the negative electrode are arranged in this order, in which the preparing the negative electrode includes: forming a first layer containing a metal of gold, platinum, or a combination thereof directly or indirectly on the separator side of a negative substrate; forming a second layer containing a polymer having lithium ion conductivity and a lithium salt and capable of restricting passage of the nonaqueous electrolyte on the separator side of the first layer; and forming a lithium metal layer between the negative substrate and the first layer.

According to the method for manufacturing an energy storage device according to item 7, the above-described energy storage device can be manufactured. That is, it is possible to manufacture an energy storage device in which the growth of dendrite is suppressed.

### Item 8.

An energy storage apparatus according to one embodiment of the present invention includes: one or a plurality of the energy storage devices according to any one of items 1 to 6; and a restraining member that restrains the one or the plurality of energy storage devices, in which the one or the plurality of energy storage devices are pressed in a thickness direction of the electrode assembly by the restraining by the restraining member, whereby the electrode assembly is pressed.

According to the energy storage apparatus according to item 8, it is possible to suppress the growth of dendrite in the energy storage apparatus toward the separator side.

An energy storage device according to one aspect of the present invention includes: an electrode assembly including a positive electrode, a negative electrode, and a separator; and a nonaqueous electrolyte, in which the negative electrode includes: a negative substrate; a first layer disposed directly or indirectly on the separator side of the negative substrate and containing a metal of gold, platinum, or a combination thereof; and a second layer disposed on the separator side of the first layer, containing a polymer having lithium ion conductivity and a lithium salt, and capable of regulating passage of the nonaqueous electrolyte, and the negative electrode further includes a lithium metal layer disposed between the negative substrate and the first layer.

Here, “regulating the passage of the nonaqueous electrolyte” means not allowing the nonaqueous electrolyte to pass completely, and specifically means that a swelling amount (absorption amount) of the nonaqueous electrolyte in the second layer is 0.25 cm³ (0.25 cm³/g) or less per 1 g of the second layer under the conditions of 25° C. and atmospheric pressure. The second layer is not a layer including a decomposition product of the nonaqueous electrolyte or the like at the time of charging the energy storage device, but is a layer formed from an initial state before charging, that is, a layer formed at the time of manufacturing the energy storage device.

According to this energy storage device, since the negative electrode includes the first layer and the second layer, the growth of dendrite toward the separator side (hereinafter, also simply referred to as “growth of dendrite”) is suppressed. The reason why the growth of dendrite is suppressed as described above is not necessarily clear, but is presumed as follows, for example.

That is, the presence of the second layer on the separator side in the first layer suppresses arrival of the nonaqueous electrolyte at the first layer, and allows lithium ions in the second layer and in the nonaqueous electrolyte swollen in the second layer to reach the first layer, and therefore, a direct contact state between the nonaqueous electrolyte and the first layer is reduced (blocking action of the nonaqueous electrolyte), and the lithium ions in the second layer and in the nonaqueous electrolyte swollen in the second layer can come into contact with the first layer.

In the energy storage device, the lithium ions in the second layer and in the nonaqueous electrolyte swollen in the second layer reach the surface of the first layer on the separator side during charging, whereby lithium metal crystals are precipitated between the first layer and the second layer. At this time, since the first layer has conductivity caused by the metal of gold, platinum, or a combination thereof, local concentration of current is suppressed on the surface of the first layer on the separator side, so that while a lithium metal crystal is easily generated relatively uniformly over the entire surface, a local lithium metal crystal is hardly generated on the surface. Thus, the growth of dendrite is suppressed. Since the first layer contains metal of gold, platinum, or a combination thereof, affinity between the first layer and lithium metal is high. As a result, the lithium metal crystal generated between the first layer and the second layer is more likely to be uniformly generated on the entire surface of the first layer on the separator side, and the particulate lithium metal crystal is more likely to be generated in a relatively dense state, so that a layer of the particulate lithium metal crystal is more likely to grow into a smoother layer. In addition, since the affinity between the first layer and the second layer is improved, when the second layer is formed on the first layer, the second layer is easily formed more uniformly on the first layer, thereby improving adhesion of the second layer to the first layer, uniformity of the thickness of the second layer, and smoothness of the second layer. As a result, local crystal formation of lithium metal can be further suppressed. Thus, the growth of dendrite is further suppressed.

When a lithium metal crystal is relatively uniformly generated over the entire surface, a particulate lithium metal crystal is easily generated in a relatively dense state, so that the particulate lithium metal crystal is easily grown into a smooth layer having relatively small irregularities and a relatively uniform thickness between the first layer and the second layer. On the other hand, in addition to suppressing the growth of dendrite by the metal of gold, platinum, or a combination thereof as described above, the local concentration of current is also suppressed by the blocking action of the nonaqueous electrolyte by the second layer described above, and thus the growth of dendrite due to direct contact between the nonaqueous electrolyte and the first layer is also suppressed by this.

As described above, since the negative electrode includes the first layer and the second layer, the first layer and the second layer cooperate to suppress the growth of dendrite, and a relatively dense and smooth lithium metal crystal layer can be formed between the first layer and the second layer. In such a smooth lithium metal crystal layer, a contact area with the nonaqueous electrolyte is small as compared with a non-smooth lithium metal crystal layer, and thus the growth of dendrite is suppressed.

Since the second layer has flexibility due to containing the polymer, the second layer can expand and contract following the crystal shape of lithium metal precipitated between the first layer and the second layer. By this expansion and contraction, the occurrence of cracking (cracks) and the like in the second layer associated with the crystal growth of the lithium metal is suppressed, so that arrival of the nonaqueous electrolyte at the first layer through the cracking and the like in the second layer, and the growth of dendrite due to local crystal formation of the lithium metal at the arrival portion is suppressed.

In addition, since the second layer contains a lithium salt, the flexibility of the second layer can be enhanced, so that cracking or the like in the second layer is further suppressed. Accordingly, the growth of dendrite is further suppressed. In addition, since the second layer contains a lithium salt, the lithium ion conductivity of the second layer can be improved, so that local concentration of current can be further suppressed. This also further suppresses the growth of dendrite.

In addition, since the negative electrode further includes a lithium metal layer disposed between the negative substrate and the first layer, the lithium metal layer functions as a negative active material layer or a supply layer of lithium metal. Therefore, the lithium metal layer contributes to charge and discharge as a negative active material layer, and can supplement an amount of electricity corresponding to lithium metal that cannot contribute to charge and discharge due to electrical isolation of the dendrite. In addition, due to the presence of the lithium metal layer, the lithium metal contained in the layer and the metal contained in the first layer are alloyed, and the layer of the crystal of the lithium metal precipitated on the first layer can be a smoother layer, and the growth of dendrite can be suppressed.

As described above, according to the energy storage device, it is presumed that the growth of dendrite is suppressed.

By suppressing the growth of dendrite as described above, the occurrence of a short circuit caused by dendrite is suppressed. Furthermore, since the growth of dendrite is suppressed, electrical isolation (generation of dead lithium) of dendrite generated by dendrite falling off from the layer of the particulate lithium metal crystal generated between the first layer and the second layer during charging is also suppressed, so that a decrease in the capacity caused by the dead lithium is suppressed, and accordingly, a decrease in discharge capacity retention ratio is also suppressed. In addition, while the growth of dendrite is reduced as described above, the layer of the particulate lithium metal crystal can be formed, so that the precipitated lithium metal crystal can be effectively used as an active material.

Here, the second layer may be formed of a polymer material containing vinylene carbonate, acrylonitrile, or a combination thereof as a monomer.

When the second layer is formed of a polymer material that easily swells the nonaqueous electrolyte, the nonaqueous electrolyte swollen in the second layer can pass to the first layer side, so that there is a possibility that local concentration of current occurs due to direct contact between the nonaqueous electrolyte and the first layer. However, when the second layer is formed of a polymer material containing vinylene carbonate, acrylonitrile, or a combination thereof as a monomer, the second layer is relatively difficult to swell the nonaqueous electrolyte, so that direct contact between the nonaqueous electrolyte and the first layer can be further reduced. Thus, the growth of dendrite is further suppressed. By further suppressing the growth of dendrite as described above, the occurrence of a short circuit caused by dendrite is further suppressed. In addition, since the growth of dendrite is further suppressed, electrical isolation (generation of dead lithium) of dendrite is also further suppressed, so that the decrease in the capacity caused by the dead lithium is suppressed, and accordingly, the decrease in the discharge capacity retention ratio is also further suppressed.

Here, the negative electrode may further include a lithium metal layer disposed between the first layer and the separator.

Although reduced as described above, the grown dendrite may not be able to contribute to charge and discharge due to electrical isolation (generation of dead lithium). However, when the negative electrode includes a lithium metal layer between the first layer and the separator, the lithium metal layer functions as the negative active material layer or the supply layer of lithium metal. Therefore, the lithium metal layer contributes to charge and discharge as the negative active material layer, and can supplement the amount of electricity corresponding to lithium metal that cannot contribute to charge and discharge due to electrical isolation (generation of dead lithium) of the dendrite.

Here, the separator may include a substrate layer and an inorganic material layer disposed on the negative electrode side of the substrate layer.

When the separator includes the inorganic material layer as described above, the growth of the precipitated lithium metal toward the separator side is further hindered by the presence of the inorganic material layer. In addition, since the penetration of the separator by the lithium metal is further suppressed by the presence of the inorganic material layer, the occurrence of a short circuit is further suppressed.

Here, the lithium salt may be lithium difluorophosphate, lithium difluoro(oxalato)borate, lithium bis(trifluoromethanesulfonyl)imide, or a combination thereof.

As described above, when the lithium salt is the compound, since the flexibility of the second layer can be further enhanced, cracking in the second layer is further suppressed. Accordingly, the growth of dendrite is further suppressed.

Here, the electrode assembly may be in a state of being pressed in a thickness direction thereof.

When the electrode assembly is pressed in the thickness direction as described above, a short circuit tends to occur as compared with a case where the electrode assembly is not pressed; however, even when the short circuit thus tends to occur, the occurrence of the short circuit is suppressed. Thus, when the electrode assembly is in the state of being pressed in the thickness direction thereof, the effect of suppressing the growth of dendrite of the energy storage device is particularly sufficiently exhibited.

A method for manufacturing an energy storage device according to another aspect of the present invention includes: preparing a positive electrode; preparing a separator; preparing a negative electrode; and producing an electrode assembly by stacking the positive electrode, the separator, and the negative electrode such that the positive electrode, the separator, and the negative electrode are arranged in this order, in which the preparing the negative electrode includes: forming a first layer containing a metal of gold, platinum, or a combination thereof directly or indirectly on the separator side of a negative substrate; forming a second layer containing a polymer having lithium ion conductivity and a lithium salt and capable of restricting passage of the nonaqueous electrolyte on the separator side of the first layer; and forming a lithium metal layer between the negative substrate and the first layer.

According to the method for manufacturing an energy storage device as described above, the above-described energy storage device can be manufactured. That is, it is possible to manufacture an energy storage device in which the growth of dendrite is suppressed.

An energy storage apparatus according to another aspect of the present invention includes: one or a plurality of the energy storage devices; and a restraining member that restrains the one or the plurality of energy storage devices, in which the one or the plurality of energy storage devices are pressed in a thickness direction of the electrode assembly by the restraining by the restraining member, whereby the electrode assembly is pressed.

Since such an energy storage apparatus includes the energy storage device, the growth of dendrites is suppressed. In addition, since the energy storage device is pressed in the thickness direction of the electrode assembly so that the electrode assembly is in the state of being pressed in the thickness direction of the electrode assembly, as described above, the occurrence of the short circuit is suppressed even in a state where the short circuit is relatively likely to occur.

An energy storage device, the configuration of an energy storage apparatus, and a method for manufacturing the energy storage device according to an embodiment of the present invention, and other embodiments will be described in detail. It is to be noted that the names of the respective constituent members (respective constituent elements) for use in the respective embodiments may be different from the names of the respective constituent members (respective elements) for use in the background art.

### <Configuration of Energy Storage Device>

An energy storage device according to an embodiment of the present invention includes: an electrode assembly including a positive electrode, a negative electrode, and a separator; a nonaqueous electrolyte; and a case that houses the electrode assembly and the nonaqueous electrolyte. The electrode assembly is typically a stacked type obtained by stacking a plurality of positive electrodes and a plurality of negative electrodes with separators interposed therebetween, or a wound type obtained by winding a positive electrode and a negative electrode stacked with a separator interposed therebetween. The nonaqueous electrolyte is present in a state of being contained in the positive electrode, the negative electrode, and the separator. A nonaqueous electrolyte secondary battery (hereinafter, also referred to simply as a “secondary battery”) will be described as an example of the energy storage device.

### (Positive Electrode)

The positive electrode includes a positive substrate and a positive active material layer disposed directly on the positive substrate or over the positive substrate with an intermediate layer interposed therebetween.

The positive substrate has conductivity. Whether the positive substrate has “conductivity” or not is determined with the volume resistivity of 10⁷ Ω·cm measured in accordance with JIS-H-0505 (1975) as a threshold. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and A1N30 specified in JIS-H-4000 (2014) or JIS-H-4160 (2006).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. By setting the average thickness of the positive substrate to the above range, it is possible to increase the energy density per volume of a secondary battery while increasing the strength of the positive substrate. The “average thickness of the positive substrate” refers to a value obtained by dividing a cutout mass in cutout of a positive substrate that has a predetermined area by a true density and a cutout area of the positive substrate.

The intermediate layer is a layer disposed between the positive substrate and the positive active material layer. The intermediate layer includes a conductive agent such as carbon particles to reduce contact resistance between the positive substrate and the positive active material layer. The configuration of the intermediate layer is not particularly limited, and includes, for example, a binder and a conductive agent.

The positive active material layer includes a positive active material. The positive active material layer contains optional components such as a conductive agent, a binder (binding agent), a thickener, a filler, or the like as necessary.

The positive active material can be appropriately selected from known positive active materials. As the positive active material, a material capable of storing and releasing lithium ions is usually used. Examples of the positive active material include lithium-transition metal composite oxides that have an α-NaFeO₂-type crystal structure, lithium-transition metal composite oxides that have a spinel-type crystal structure, polyanion compounds, chalcogenides, and sulfur. Examples of the lithium-transition metal composite oxides that have an α-NaFeO₂-type crystal structure include Li[LiₓNi₍₁₋ₓ₎]O₂ (0≤x<0.5), Li[LiₓNi_{γ}Co_{(1-x-γ)}]O₂ (0≤x<0.5, 0<γ<1), Li[LiₓCo₍₁₋ₓ₎]O₂ (0≤x<0.5), Li[LiₓNi_{γ}Mn_{(1-x-γ)}]O₂ (0≤x<0.5, 0<γ<1), Li[LiₓNi_{γ}Mn_{β}Co_{(1-x-γ-β)}]O₂ (0≤x<0.5, 0<γ, 0<β, 0.5<γ+β<1), and Li[LiₓNi_{γ}Co_{β}Al_{(1-x-γ-β)}]O₂ (0≤x<0.5, 0<γ, 0<β, 0.5<γ+β<1). Examples of the lithium-transition metal composite oxides that have a spinel-type crystal structure include LiₓMn₂O₄ and LiₓNi_{γ}Mn_{(2-γ)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. Some of atoms or polyanions in these materials may be substituted with atoms or anion species composed of other elements. The surfaces of these materials may be coated with other materials. In the positive active material layer, one of these materials may be used singly, or two or more thereof may be used in mixture.

The positive active material is usually a particle (powder). The average particle size of the positive active material is preferably 0.1 μm or more and 20 μm or less, for example. By setting the average particle size of the positive active material to be equal to or more than the lower limit mentioned above, the positive active material is easily manufactured or handled. By setting the average particle size of the positive active material to be equal to or less than the upper limit mentioned above, the electron conductivity of the positive active material layer is improved. In the case of using a composite of the positive active material and another material, the average particle size of the composite is regarded as the average particle size of the positive active material. The “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher, a classifier, or the like is used in order to obtain a powder with a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As a classification method, a sieve or a wind force classifier or the like is used based on the necessity both in dry manner and in wet manner.

The content of the positive active material in the positive active material layer is preferably 50% by mass or more and 99% by mass or less, more preferably 70% by mass or more and 98% by mass or less, and still more preferably 80% by mass or more and 95% by mass or less. By setting the content of the positive active material in the above range, it is possible to achieve both high energy density and productivity of the positive active material layer.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used alone, or two or more thereof may be used in mixture. In addition, these materials may be used in combination. For example, a composite material of carbon black and CNT may be used. Among these materials, carbon black is preferable from the viewpoints of electron conductivity and coatability, and in particular, acetylene black is preferable.

The content of the conductive agent in the positive active material layer is preferably 1% by mass or more and 10% by mass or less, more preferably 3% by mass or more and 9% by mass or less. By setting the content of the conductive agent in the above range, the energy density of the secondary battery can be enhanced.

Examples of the binder mentioned above include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 3% by mass or more and 9% by mass or less. By setting the content of the binder in the above range, the active material can be stably held.

Examples of the thickener include polysaccharide polymers such as a carboxymethylcellulose (CMC) and a methylcellulose. When the thickener mentioned above has a functional group that is reactive with lithium and the like, the functional group may be deactivated by methylation or the like in advance.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

The positive active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Nb, and W as a component other than the positive active material, the conductive agent, the binder, the thickener, and the filler.

### (Negative Electrode)

The negative electrode includes a negative substrate, a first layer disposed directly or indirectly on the negative substrate and containing a metal (hereinafter, also referred to as “non-lithium metal”) of gold, platinum, or a combination thereof, a second layer disposed on the separator side in the first layer, containing a polymer (hereinafter, also referred to as “lithium ion conductive polymer”) having lithium ion conductivity, and capable of regulating passage of the nonaqueous electrolyte, and a lithium metal layer disposed between the negative substrate and the first layer.

The negative substrate has conductivity. As the material of the negative substrate, a metal such as copper, nickel, stainless steel, nickel-plated steel, or lithium, an alloy thereof, a carbonaceous material, or the like is used. Among these metals and alloys, the copper or copper alloy is preferable. When the material of the negative substrate is lithium metal or a lithium alloy, the lithium metal or the lithium alloy also corresponds to the negative active material or the lithium metal layer. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include rolled copper foils and electrolytic copper foils.

For example, when the material of the negative substrate is copper, nickel, stainless steel, nickel-plated steel, an alloy thereof, or a carbon material, the average thickness of the negative substrate is preferably 2 μm or more and 35 μm or less, more preferably 3 μm or more and 30 μm or less, still more preferably 4 μm or more and 25 μm or less, particularly preferably 5 μm or more and 20 μm or less. When the average thickness of the negative substrate is within the above range, it is possible to enhance the energy density per volume of a secondary battery while increasing the strength of the negative substrate. For example, when the material of the negative substrate is lithium metal or a lithium alloy, the average thickness thereof may be appropriately set in consideration of performance required as a negative active material. In this case, the average thickness of the negative substrate may be set to more than 0 μm and 100 μm or less. The “average thickness” of the negative substrate refers to an average value of thicknesses measured at arbitrary five positions with a micrometer. Hereinafter, the same applies to the average thicknesses of the separator, the substrate layer, and the inorganic material layer.

### (First Layer)

The first layer contains a non-lithium metal. The first layer preferably contains a non-lithium metal as a main component. Here, the “main component” is a component having the largest content, and means, for example, a component having a content of 50% by mass or more. The lower limit of the content of the non-lithium metal in the first layer is preferably 50% by mass, more preferably 90% by mass, still more preferably 95% by mass, and even more preferably 99% by mass as described above. When the content of the non-lithium metal in the first layer is equal to or more than the lower limit mentioned above, the growth of dendrite can be more reliably suppressed. On the other hand, the upper limit of the content of the non-lithium metal in the first layer may be 100% by mass.

The lower limit of the average thickness of the first layer is preferably 5 nm, and more preferably 10 nm. On the other hand, the upper limit of the average thickness of the first layer is preferably 200 nm, and more preferably 150 nm. When the average thickness of the first layer is in the above range, the growth of dendrite is more reliably suppressed. The average thickness of the first layer is determined by dividing the mass of the first layer by the area of the first layer and further by a true density of the first layer. When the average thickness of the first layer cannot be obtained by the method because the first layer is porous or an alloy, the average thickness of the first layer may be obtained by subtracting the average thickness of the negative substrate and the average thickness of the lithium metal layer from the average thickness of the entire negative electrode. In this case, the average thickness of the negative electrode and the lithium metal layer refers to an average value measured at arbitrary five positions with a micrometer.

From the viewpoint of generating lithium metal crystal relatively uniformly over the entire separator side surface of the first layer, the first layer is preferably non porous and also preferably dense. It is preferable that the first layer is formed by sputtering from the viewpoint that the first layer is non-porous and dense as described above.

The non-lithium metal is preferably a metal other than the metal which is the main component of the negative substrate. The non-lithium metal has high affinity for lithium metal. Since this affinity is high, when lithium metal crystal is precipitated between the first layer and the second layer, the lithium metal crystal is easily generated relatively uniformly over the entire surface of the first layer, and particulate lithium metal crystal is easily generated in a relatively dense state. As a result, the growth of dendrite can be reduced, and on the other hand, the layer of the particulate lithium metal crystal can be easily formed smoother with a more uniform thickness. The affinity of the non-lithium metal for the lithium metal can be rephrased as the affinity of the lithium metal for the non-lithium metal or the affinity between the non-lithium metal and the lithium metal.

In addition, the non-lithium metal preferably has high wettability to a lithium ion conductive polymer solution of the second layer. When the wettability is high, the smoother second layer having higher adhesion to the first layer and a more uniform thickness can be formed on the first layer, so that local crystal formation of lithium metal due to deterioration of the properties can be suppressed. In addition, cracking or the like of the second layer associated with the growth of lithium metal crystal can be suppressed. The wettability of the non-lithium metal to the lithium ion conductive polymer solution can be rephrased as the wettability of the lithium ion conductive polymer to the non-lithium metal or the wettability between the non-lithium metal and the lithium ion conductive polymer.

As described above, it is preferable that both the affinity of the non-lithium metal for the lithium metal and the wettability of the non-lithium metal to the lithium ion conductive polymer solution are high when considering that while the first layer and the second layer cooperate to suppress the growth of dendrite, a smooth layer of particulate lithium metal crystal is generated.

Examples of an index of the affinity of the non-lithium metal for lithium metal and the wettability of the non-lithium metal for the lithium ion conductive polymer solution include a contact angle of a reference solution with respect to the non-lithium metal using a polyvinylene carbonate (PVC) solution as the reference solution. As the contact angle of the reference solution with respect to the non-lithium metal is smaller, the affinity of the non-lithium metal with respect to the lithium metal tends to be higher, and the wettability of the non-lithium metal with respect to the lithium ion conductive polymer solution tends to be higher. On the other hand, when the contact angle is too small, it may be difficult to form the second layer on the first layer. In consideration of this point, the lower limit of the contact angle of the reference solution with respect to the non-lithium metal is preferably, for example, 2°, and more preferably 5°. On the other hand, the upper limit of the contact angle is, for example, preferably 40°, and more preferably 35°.

The contact angle is measured as follows. First, a PVC solution obtained by mixing PVC and dimethylsulfoxide (DMSO) at a mass ratio of 15:85 is used as a reference solution, and 0.02 mL of the reference solution is added dropwise to an upper surface of disk-shaped non-lithium metal having a diameter of 20 mm under an environment of 25° C. Next, after a lapse of 10 minutes from the dropwise addition, photographs of the droplets of the non-lithium metal and the reference solution are taken from any one side (parallel to the upper surface of the non-lithium metal), and in the obtained image, an angle formed by a tangent of a contour curve at any one intersection of the contour curve of the droplet and the upper surface of the non-lithium metal with respect to the upper surface of the non-lithium metal is measured, so that the obtained angle is determined as a contact angle. It is determined that the affinity of the non-lithium metal for the lithium metal and the wettability of the non-lithium metal for the lithium ion conductive polymer solution are higher as the contact angle is smaller.

In addition to the contact angle, examples of the index of the affinity of the non-lithium metal for the lithium metal and the wettability of the non-lithium metal for the lithium ion conductive polymer solution include a degree of spread of the reference solution on the upper surface of the non-lithium metal. As the degree of spread of the reference solution on the upper surface of the non-lithium metal is higher, the affinity of the non-lithium metal with respect to the lithium metal tends to be higher, and the wettability of the non-lithium metal with respect to the lithium ion conductive polymer solution tends to be higher. In consideration of this point, the lower limit of the degree of spread of the reference solution on the upper surface of the non-lithium metal (maximum diameter of droplets) is preferably, for example, 6.0 mm, and more preferably 6.5 mm. On the other hand, the upper limit of the degree of spread of the reference solution is not particularly limited. The upper limit may be, for example, 10 mm.

The degree of spread of the solution is measured as follows. First, the reference solution is used as a solution, and 0.02 mL of the reference solution is added dropwise to the upper surface of disk-shaped non-lithium metal having a diameter of 20 mm under an environment of 25° C. Subsequently, after a lapse of 5 minutes from the dropwise addition, photographs of the droplets of the non-lithium metal and the reference solution are taken from above them (perpendicularly to the upper surface of the non-lithium metal), and in the obtained image, a maximum diameter of the contour curve of the droplet is measured, so that the obtained maximum diameter is determined as the degree of spread. It is determined that the affinity of the non-lithium metal for the lithium metal and the wettability of the non-lithium metal for the lithium ion conductive polymer solution are higher as the degree of spread is higher.

In addition, the wettability of the non-lithium metal to the lithium ion conductive polymer solution is preferably higher than the wettability of the lithium metal to the lithium ion conductive polymer solution. That is, the contact angle of the reference solution with respect to the non-lithium metal is preferably smaller than the contact angle of the reference solution with respect to the lithium metal, and the degree of spread of the reference solution on the upper surface of the non-lithium metal is preferably larger than the degree of spread of the reference solution on the upper surface of the lithium metal. As described above, since the wettability of the non-lithium metal to the lithium ion conductive polymer solution is higher than the wettability of the lithium metal to the lithium ion conductive polymer solution, the affinity between the first layer and the lithium metal can be increased, and the affinity between the first layer and the second layer can be increased.

The non-lithium metal is a metal of gold, platinum, or a combination thereof. Since the first layer contains gold, platinum, or a combination thereof as metal, the affinity between the first layer and lithium metal is high. As a result, the lithium metal crystal generated between the first layer and the second layer is more likely to be uniformly generated on the entire surface of the first layer on the separator side, and the particulate lithium metal crystal is more likely to be generated in a relatively dense state, so that a layer of the particulate lithium metal crystal is more likely to grow into a smoother layer. In addition, since the affinity between the first layer and the second layer is improved, when the second layer is formed on the first layer, the second layer is easily formed more uniformly on the first layer, thereby improving the adhesion of the second layer to the first layer, the uniformity of the thickness of the second layer, and the smoothness of the second layer. As a result, local crystal formation of lithium metal can be further suppressed. Thus, the growth of dendrite is further suppressed.

From the viewpoint of enhancing the affinity of the first layer for lithium metal, the first layer is preferably non porous and preferably dense as described above.

### (Second Layer)

The second layer is a layer containing a lithium ion conductive polymer and a lithium salt and capable of regulating passage of the nonaqueous electrolyte. The second layer is not a solid electrolyte interface (SEI) formed by a decomposition product of a nonaqueous electrolyte or the like during charging of the energy storage device, but a layer formed during manufacturing of the energy storage device. While the SEI is a non-uniform and porous layer due to its generation process, the second layer is preferably a uniform layer and a non-porous layer as compared with the SEI. When the second layer is non-porous as described above, the second layer can more sufficiently regulate the passage of the nonaqueous electrolyte, and on the other hand, the second layer can pass lithium ions due to containing the lithium ion conductive polymer. On the other hand, the SEI allows the nonaqueous electrolyte to pass therethrough. The “non porous layer” refers to a layer having no continuous pores in the thickness direction through which the nonaqueous electrolyte passes, and this layer may have pores through which the nonaqueous electrolyte does not pass.

In the above-described SEI that is porous, since the nonaqueous electrolyte passes through the first layer, lithium metal crystal is locally generated on the surface of the first layer on the separator side, and dendrites easily grow. On the other hand, the second layer can suppress local crystal formation of lithium metal on the surface of the first layer on the separator side by regulating the passage of the nonaqueous electrolyte, and on the other hand, can relatively uniformly generate lithium metal crystal over the entire surface. When the second layer is non-porous as described above, it is possible to suppress the growth of dendrite and to suppress the penetration of dendrite through the second layer. Furthermore, since the second layer has flexibility due to containing the lithium ion conductive polymer, the second layer can expand and contract following the crystal shape of lithium metal precipitated between the first layer and the second layer. As a result, in the second layer, occurrence of cracking or the like associated with the growth of lithium metal crystal is suppressed. On the other hand, since the SEI does not contain the lithium ion conductive polymer, the SEI is poor in flexibility.

The lower limit of the content of the lithium ion conductive polymer in the second layer is preferably 30% by mass, more preferably 50% by mass, still more preferably 70% by mass, and even more preferably 90% by mass. When the content of the lithium ion conductive polymer is equal to or more than the lower limit mentioned above, the growth of dendrite can be more reliably suppressed. On the other hand, the upper limit of the content of the lithium ion conductive polymer in the second layer is preferably 99% by mass, and more preferably 95% by mass.

The lower limit of the average thickness of the second layer is preferably 0.01 μm, more preferably 0.1 μm, and still more preferably 0.5 μm. On the other hand, the upper limit of the average thickness of the second layer is preferably 3 μm, and more preferably 1 μm. When the average thickness of the second layer is in the above range, the growth of dendrite is more reliably suppressed. The average thickness of the second layer is determined by subtracting the average thickness of the negative substrate, the average thickness of the lithium metal layer, and the average thickness of the first layer from the average thickness of the entire negative electrode.

The lithium ion conductive polymer is preferably one that hardly swells (hardly compatibilizes) the nonaqueous electrolyte. In this respect, the lithium ion conductive polymer is preferably a carbonate-based polymer, a nitrile-based polymer, or a combination thereof, that is, is preferably formed of a polymer material containing a carbonate-based monomer, a nitrile-based monomer, or a combination thereof. Such a lithium ion conductive polymer has a structural unit derived from the carbonate-based monomer or the nitrile-based monomer.

Examples of the carbonate-based monomer include a chain carbonate-based monomer and a cyclic carbonate-based monomer, and among these, a cyclic carbonate-based monomer is preferable. Examples of the cyclic carbonate-based monomer include vinylene carbonate (VC), ethylene carbonate (EC), and propylene carbonate (PC), and one of these may be used alone, or a combination of two or more thereof may be used. Among them, as the carbonate-based monomer as the monomer of the lithium ion conductive polymer, VC or PC is preferable, and VC is more preferable. That is, the lithium ion conductive polymer is more preferably formed of a polymer material containing VC as a monomer. Since the second layer is formed of a polymer material containing VC as a monomer, the second layer is relatively difficult to swell the nonaqueous electrolyte, so that direct contact between the nonaqueous electrolyte and the first layer can be further reduced. Thus, the growth of dendrite is further suppressed.

The nitrile-based monomer is a monomer having a carbon-carbon double bond and having a nitrile group. Examples of the nitrile-based monomer include acrylonitrile (AN) and methacrylonitrile, and one of these may be used alone, or a combination of two or more thereof may be used. Among them, AN is preferable as the nitrile-based monomer as the monomer of the lithium ion conductive polymer. That is, the lithium ion conductive polymer is more preferably formed of a polymer material containing AN as a monomer. Since the second layer is formed of a polymer material containing AN as a monomer, the second layer is relatively difficult to swell the nonaqueous electrolyte, so that direct contact between the nonaqueous electrolyte and the first layer can be further reduced. Thus, the growth of dendrite is further suppressed. In addition, in the second layer (nitrile-based second layer) formed of a polymer material containing a nitrile-based monomer, the swelling amount of the nonaqueous electrolyte per unit mass tends to be smaller than that of the second layer (carbonate-based second layer) formed of a carbonate-based monomer, so that direct contact between the nonaqueous electrolyte and the first layer can be further reduced. On the other hand, since the nitrile-based second layer tends to have higher resistance than the carbonate-based second layer, the nitrile-based second layer preferably contains a lithium salt from the viewpoint of enhancing lithium ion conductivity.

The polymer material may contain both a carbonate-based monomer and a nitrile-based monomer. The lithium ion conductive polymer may be a copolymer formed of the carbonate-based monomer and the nitrile-based monomer, or a mixture of polymers formed of only one of these monomers. The polymer material may contain a monomer other than the carbonate-based monomer and the nitrile-based monomer. The lithium ion conductive polymer may be a polymer formed of only at least one of the carbonate-based monomer and the nitrile-based monomer, a copolymer formed of at least one of the carbonate-based monomer and the nitrile-based monomer and other monomers, or a mixture of polymers formed of only one of these monomers. For example, the lithium ion conductive polymer may be at least one of polyvinylene carbonate (PVC) and polyacrylonitrile (PAN), a copolymer of at least one of VC and AN and other monomers, or a mixture thereof. The content of at least one of the carbonate-based monomer and the nitrile-based monomer with respect to the total (all monomers) of at least one of the carbonate-based monomer and the nitrile-based monomer and other monomers is preferably 10 mol % or more and 90 mol % or less, and preferably 20 mol % or more and 80 mol % or less.

The second layer further contains a lithium salt. Since the second layer contains a lithium salt, the flexibility of the second layer can be enhanced, so that cracking or the like in the second layer is further suppressed. Accordingly, the growth of dendrite is further suppressed. In addition, since the second layer contains a lithium salt, the lithium ion conductivity of the second layer can be improved, so that local concentration of current can be further suppressed. This also further suppresses the growth of dendrite.

The lower limit of the content of the lithium salt in the second layer is preferably 2% by mass, and more preferably 5% by mass. The lower limit of the content of the lithium salt with respect to 100 parts by mass of the lithium conductive polymer in the second layer is preferably 2 parts by mass, and more preferably 5 parts by mass. On the other hand, the upper limit of the content of the lithium salt in the second layer is preferably 70% by mass, more preferably 50% by mass, still more preferably 30% by mass, and even more preferably 20% by mass. The upper limit of the content of the lithium salt with respect to 100 parts by mass of the lithium conductive polymer in the second layer is preferably 240 parts by mass, more preferably 100 parts by mass, and still more preferably 50 parts by mass. When the content of the lithium salt is equal to or more than the lower limit mentioned above, the growth of dendrite can be more reliably suppressed. On the other hand, when the content of the lithium salt is equal to or less than the upper limit mentioned above, the swelling amount of the nonaqueous electrolyte in the second layer can be reduced.

The lithium salt is preferably compatible with the lithium ion conductive polymer. In addition, the lithium salt is preferably relatively hardly soluble in the nonaqueous electrolyte. In consideration of this point, the lithium salt can be appropriately selected according to the types of the nonaqueous electrolyte and the lithium ion conductive polymer. Examples of the lithium salt include lithium difluorophosphate (LiDFP), lithium difluoro(oxalato)borate (LiDFOB), lithium bis(oxalato)borate (LiBOB), lithium bis(pentafluoroethanesulfonyl)imide (LiBETI), and lithium bis(trifluoromethanesulfonyl)imide (LiTFSI), and among these, LiDFP, LiDFOB, LiTFSI, or a combination thereof is preferable. The second layer may contain the lithium salt alone or two or more kinds thereof. As described above, when the lithium salt is the compound, since the flexibility of the second layer can be further enhanced, cracking in the second layer is further suppressed. Accordingly, the growth of dendrite is further suppressed.

### (Lithium Metal Layer)

The negative electrode preferably further includes a lithium metal layer (hereinafter, also referred to as “first lithium metal layer”) between the first layer and the separator, and more preferably includes a first lithium metal layer between the first layer and the second layer. The first lithium metal layer functions as a negative active material layer or a supply layer of lithium metal. Therefore, the first lithium metal layer contributes to charge and discharge as the negative active material layer, and can supplement the amount of electricity corresponding to lithium metal that is reduced but cannot contribute to charge and discharge due to electrical isolation of grown dendrite. As shown in FIG. 2, when the negative electrode includes the first lithium metal layer between the first layer and the second layer, the first lithium metal layer can be formed as a layer of particulate lithium metal crystal between the first layer and the second layer by charge (initial charge and subsequent charge) as described above. When the negative electrode includes the first lithium metal layer formed by charge, the negative electrode may not include the first lithium metal layer in a discharged state.

When the first lithium metal layer is formed by charge, the average thickness of the first lithium metal layer depends on a capacity density, a depth of charge and discharge, and the like in charge and discharge of the energy storage device. Therefore, the average thickness of the first lithium metal layer is appropriately set according to the capacity density, the depth of charge and discharge, and the like.

The negative electrode further includes a lithium metal layer (hereinafter, also referred to as a “second lithium metal layer”) between the negative substrate and the first layer. The second lithium metal layer functions as a negative active material layer or a supply layer of lithium metal. Therefore, the second lithium metal layer contributes to charge and discharge as the negative active material layer, and can supplement the amount of electricity corresponding to lithium metal that cannot contribute to charge and discharge due to electrical isolation of the dendrite. The second lithium metal layer is formed between the negative substrate and the first layer at the time of manufacturing the energy storage device. The second lithium metal layer can be produced, for example, by cutting a lithium metal foil into a predetermined shape or molding the lithium metal foil into a predetermined shape.

Considering that the second lithium metal layer is the supply layer of lithium metal as described above, the larger the average thickness of the second lithium metal layer is, the longer the charge-discharge cycle becomes possible, which is preferable. For example, the average thickness of the second lithium metal layer may be set so that the energy storage device achieves a gravimetric energy density of 400 Wh/kg and maintains a capacity retention ratio of 80% after 200 cycles of charge and discharge. On the other hand, as the average thickness of the second lithium metal layer increases, the energy storage device may be unnecessarily increased in size. The average thickness of the second lithium metal layer is also set according to coulombic efficiency in charge and discharge. Thus, for example, the average thickness of the second lithium metal layer may be appropriately set in consideration of these points. For example, the lower limit of the average thickness of the second lithium metal layer is preferably more than 0 μm, and may be more preferably 10 μm. On the other hand, the upper limit of the average thickness of the second lithium metal layer may be preferably 100 μm, and more preferably 60 μm. The “average thickness of the second lithium metal layer” refers to an average value of thicknesses measured at arbitrary five points. This average thickness is calculated by subtracting the average thickness of the negative substrate from the average thickness measured at arbitrary five points for a layered product of the negative substrate and the second lithium metal layer.

The first and second lithium metal layers contain lithium metal as a negative active material. Since the first and second lithium metal layers contain lithium metal as the negative active material, the discharge capacity per mass of the active material can be improved. The lithium metal includes a lithium alloy as well as a simple substance of lithium metal. Examples of the lithium alloy include lithium-aluminum alloy.

When a metal foil (for example, a copper foil) is used as the negative substrate, an alloy layer containing a metal (for example, a copper metal) as a component of the negative substrate and a lithium metal may be formed between the negative substrate and the second lithium metal layer.

The negative electrode may include an intermediate layer between the negative substrate and the second lithium layer. The intermediate layer contains a conductive agent such as carbon particles to decrease the contact resistance between the negative substrate and the second lithium metal layer. The configuration of the intermediate layer is not particularly limited, and includes, for example, a binder and a conductive agent.

### (Separator)

The separator includes a substrate layer. The separator may include a substrate layer and an inorganic material layer disposed on the negative electrode side of the substrate layer. When the separator includes the inorganic material layer as described above, the growth of the lithium metal precipitated as described above toward the separator side is hindered by the presence of the inorganic material layer. Thus, since the penetration of the separator by the lithium metal is suppressed, the occurrence of a short circuit is further suppressed.

As described above, as the separator, for example, a separator including only a substrate layer, a separator in which an inorganic material layer is formed on one surface or both surfaces of the substrate layer, or the like can be used. Examples of the form of the substrate layer include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material for the substrate layer, for example, a polyolefin such as polyethylene or polypropylene is preferable from the viewpoint of shutdown function, and polyimide, aramid, or the like is preferable from the viewpoint of resistance to oxidative decomposition. As the substrate layer of the separator, a material obtained by combining these resins may be used.

The inorganic material layer is a layer formed using inorganic particles as a forming material. The inorganic material layer is a porous layer. The inorganic material layer preferably has heat resistance. The inorganic particles preferably have a mass loss of 5% or less in the case of temperature increase from room temperature to 500° C. under the air atmosphere of 1 atm, and more preferably have a mass loss of 5% or less in the case of temperature increase from room temperature to 800° C. Examples of the inorganic compound constituting the inorganic particles include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compounds, simple substances or complexes of these substances may be used alone, or two or more thereof may be used in mixture. Among these inorganic compounds, the silicon oxide, aluminum oxide, or aluminosilicate is preferable from the viewpoint of the safety of the energy storage device. The inorganic material layer may contain a binder, and as the binder, the same binder as the binder contained in the positive active material layer described above can be used.

The porosity of the separator is preferably 80% by volume or less from the viewpoint of strength, and is preferably 20% by volume or more from the viewpoint of discharge performance. The term “porosity” herein is a volume-based value, and means a value measured with a mercury porosimeter.

When the separator includes the substrate layer and the inorganic material layer, the separator is produced, for example, by mixing with a known dispersion medium such as the inorganic particles, a binder, and an organic solvent, applying the obtained mixture to at least one surface of the substrate layer, and drying the dispersion medium. In addition, the separator is produced, for example, by applying the mixture onto a known substrate, drying the mixture to form a sheet-like inorganic material layer, then peeling off the obtained inorganic material layer from the substrate, and laminating the inorganic material layer on at least one surface of the substrate layer using a known adhesive.

As the average thickness of the substrate layer is larger, dendrite tends to be less likely to penetrate the substrate layer. On the other hand, when the average thickness of the substrate layer is too large, the gravimetric energy density of the energy storage device tends to decrease. Thus, for example, the average thickness of the substrate layer can be appropriately set in consideration of these points, and for example, the lower limit of the average thickness of the substrate layer may be preferably 3 μm and more preferably 6 μm. On the other hand, the upper limit of the average thickness of the substrate layer is preferably 50 μm, and more preferably 25 μm in some cases.

As the average thickness of the inorganic material layer is larger, dendrite tends to be less likely to penetrate the inorganic material layer. In addition, since the inorganic material layer is a porous layer, a current distribution tends to approach uniformity as the average thickness of the inorganic material layer increases. On the other hand, when the average thickness of the inorganic material layer is too large, the gravimetric energy density of the energy storage device tends to decrease. Thus, for example, the average thickness of the inorganic material layer can be appropriately set in consideration of these points. For example, the lower limit of the average thickness of the inorganic material layer is preferably 2 μm, and more preferably 3 μm in some cases. On the other hand, the upper limit of the average thickness of the inorganic material layer is preferably 10 μm, and more preferably 6 μm in some cases.

### (Layer Configuration of Electrode Assembly)

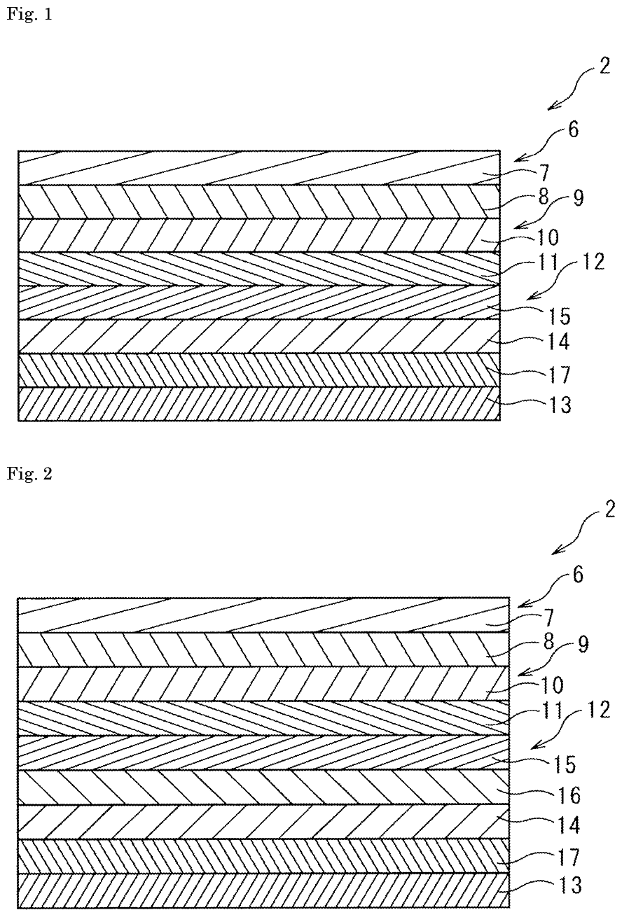

As shown in FIGS. 1 to 2, examples of a layer configuration of the electrode assembly provided in the energy storage device include the following aspects.

For example, in the aspect illustrated in FIG. 1, an electrode assembly 2 includes a positive electrode 6, a separator 9, and a negative electrode 12. Specifically, in the aspect of FIG. 1, the positive electrode 6 includes a positive substrate 7 and a positive active material layer 8 disposed on the separator 9 side of the positive substrate 7. The separator 9 includes a substrate layer 10 and an inorganic material layer 11 disposed on the negative electrode 12 side of the substrate layer 10. The negative electrode 12 has a layer configuration including a negative substrate 13, a first layer 14 disposed on the separator 9 side of the negative substrate 13, and a second layer 15 disposed on the separator 9 side of the first layer 14, and further including a second lithium metal layer 17 between the negative substrate 13 and the first layer 14. In the electrode assembly 2 having the layer configuration as illustrated in FIG. 1, lithium metal crystal is precipitated between the first layer 14 and the second layer 15 by charge, whereby a first lithium metal layer 16 as illustrated in FIG. 2 may be formed, and the layer configuration of the electrode assembly 2 may be changed to the layer configuration as illustrated in FIG. 2. On the other hand, the layer configuration of the electrode assembly 2 may be returned to the layer configuration of FIG. 1 by discharge.

For example, in the aspect illustrated in FIG. 2, the electrode assembly 2 has the same layer configuration as the layer configuration in FIG. 1, except that the negative electrode 12 further includes the first lithium metal layer 16 between the first layer 14 and the second layer 15 in addition to FIG. 1. The first lithium metal layer 16 of the electrode assembly 2 illustrated in FIG. 2 may be formed by charging the electrode assembly 2 illustrated in FIG. 1 described above, and the layer configuration of the electrode assembly 2 may be changed to the layer configuration of FIG. 1 by discharge.

### (Nonaqueous Electrolyte)

The nonaqueous electrolyte can be appropriately selected from known nonaqueous electrolytes. For the nonaqueous electrolyte, a nonaqueous electrolyte solution may be used. The nonaqueous electrolyte solution includes a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, solvents in which some of the hydrogen atoms included in these compounds are substituted with halogen may be used.

Examples of the cyclic carbonates include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these, EC and FEC are preferable.

Examples of the chain carbonates include diethyl carbonate (DEC), dimethyl carbonate (DMC), ethyl methyl carbonate (EMC), diphenyl carbonate, trifluoroethyl methyl carbonate (TFEMC), and bis(trifluoroethyl)carbonate. Among these, DMC, EMC, and TFEMC are preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When the cyclic carbonate and the chain carbonate are used in combination, the volume ratio of the cyclic carbonate to the chain carbonate (cyclic carbonate:chain carbonate) preferably falls within the range from 5:95 to 50:50, for example.

As the electrolyte salt, a lithium salt is usually used.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these salts, the inorganic lithium salts are preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, particularly preferably 0.7 mol/dm³ or more and 1.5 mol/dm³ or less. The content of the electrolyte salt falls within the range mentioned above, thereby allowing the ionic conductivity of the nonaqueous electrolyte solution to be increased.

The nonaqueous electrolyte solution may include an additive, besides the nonaqueous solvent and the electrolyte salt. Examples of the additive include halogenated carbonic acid esters such as fluoroethylene carbonate (FEC) and difluoroethylene carbonate (DFEC); oxalic acid salts such as lithium bis(oxalate)borate (LiBOB), lithium difluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used alone, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, particularly preferably 0.3% by mass or more and 3% by mass or less, with respect to a total mass of the nonaqueous electrolyte solution. The content of the additive falls within the range mentioned, thereby making it possible to improve capacity retention performance or cycle performance after high-temperature storage, and to further improve safety.

For the nonaqueous electrolyte, a solid electrolyte may be used, or a nonaqueous electrolyte solution and a solid electrolyte may be used in combination.

The solid electrolyte can be selected from arbitrary materials, which exhibit lithium ion conductivity and are solid at normal temperature (for example, from 15° C. to 25° C.). Examples of the solid electrolyte include sulfide solid electrolytes, oxide solid electrolytes, oxynitride solid electrolytes, and polymer solid electrolytes.

Examples of the sulfide solid electrolyte include Li₂S—P₂S₅, LiI—Li₂S—P₂S₅, and Li₁₀Ge—P₂S₁₂.

The shape of the energy storage device according to the present embodiment is not to be considered particularly limited, and examples thereof include cylindrical batteries, prismatic batteries, flattened batteries, coin batteries and button batteries.

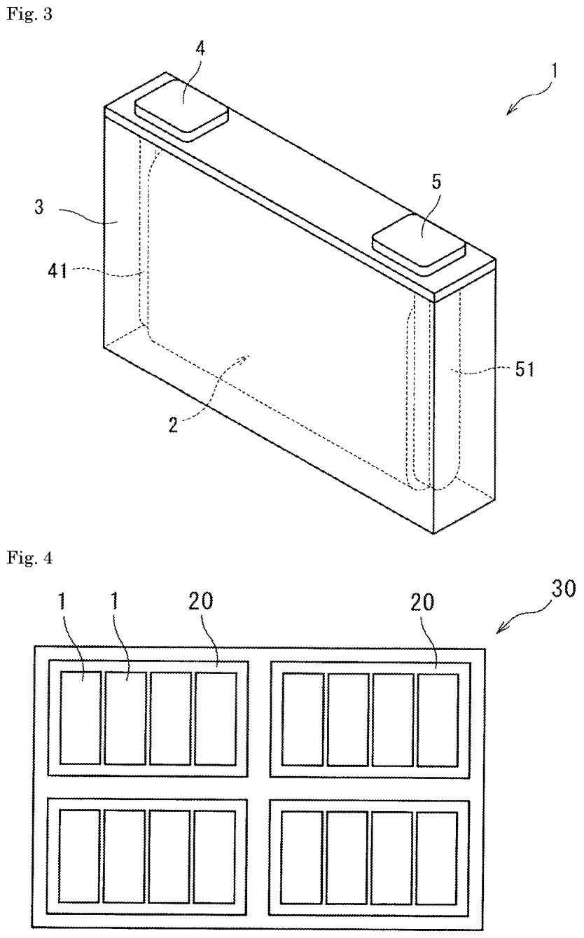

FIG. 3 illustrates an energy storage device 1 as an example of a prismatic battery. FIG. 3 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51. A nonaqueous electrolyte is injected in the case 3.

In the energy storage device of the present embodiment, it is preferable that the electrode assembly is in the state of being pressed in the thickness direction thereof. When the electrode assembly is pressed in the thickness direction as described above, a short circuit tends to occur as compared with a case where the electrode assembly is not pressed; however, even when the short circuit thus tends to occur, the occurrence of the short circuit is suppressed. Thus, when the electrode assembly is in the state of being pressed in the thickness direction thereof, the effect of suppressing the growth of dendrite of the energy storage device is particularly sufficiently exhibited. For example, in the energy storage device 1 illustrated in FIG. 3, by restraining the case 3 in a thickness direction of the electrode assembly 2 (a direction from a front left side to a back right side in FIG. 3) by a restraining member (not illustrated) or the like, the electrode assembly 2 can be brought into the state of being pressed in the thickness direction. The pressure applied to the case is adjusted, for example, by changing a distance in the thickness direction in the restraining member. The lower limit of the pressing force is preferably 0.01 MPa, and more preferably 0.2 MPa. On the other hand, the upper limit of the pressing force is preferably 2 MPa, and more preferably 1 MPa. When the pressing force is within the above range, the effect of suppressing the growth of dendrite is more sufficiently exhibited. The pressing force is measured by observing a change in coloring of pressure-sensitive paper disposed between the restraining member and the energy storage device 1 to be pressed.

### <Configuration of Energy Storage Apparatus>

The energy storage device according to the present embodiment can be mounted as an energy storage unit (battery module) configured with a plurality of energy storage devices assembled, on power sources for automobiles such as electric vehicles (EV), hybrid vehicles (HEV), and plug-in hybrid vehicles (PHEV), power sources for electronic devices such as personal computers and communication terminals, power sources for power storage, or the like. In this case, the technique of the present invention may be applied to at least one energy storage device included in the energy storage unit.

FIG. 4 shows an example of an energy storage apparatus 30 formed by assembling energy storage units 20 in each of which two or more electrically connected energy storage devices 1 are assembled. The energy storage apparatus 30 may include a busbar (not illustrated) that electrically connects two or more energy storage devices 1, a busbar (not illustrated) that electrically connects two or more energy storage units 20, and the like. The energy storage unit 20 or the energy storage apparatus 30 may include a state monitor (not shown) that monitors the conditions of one or more energy storage devices.

The energy storage apparatus of the present embodiment includes: the one or a plurality of energy storage devices; and a restraining member that restrains the one or the plurality of energy storage devices, and it is preferable that the one or the plurality of energy storage devices are pressed in a thickness direction by the restraining by the restraining member, whereby the electrode assembly is pressed. In the energy storage device thus configured, for example, in the energy storage apparatus 30 which includes the plurality of energy storage devices 1 illustrated in FIG. 4, by restraining the plurality of energy storage devices 1 in the thickness direction (left-right direction in FIG. 4) of the electrode assembly 2 by a restraining member (not illustrated), the electrode assembly 2 of the plurality of energy storage devices 1 can be brought into the state of being pressed in the thickness direction. When the energy storage apparatus includes one energy storage device, the energy storage device is restrained in the thickness direction of the electrode assembly by the restraining member, whereby the electrode assembly can be brought into the state of being pressed in the thickness direction.

### <Method for Manufacturing Energy Storage Device>

A method for manufacturing an energy storage device according to the present embodiment includes: preparing a positive electrode; preparing a separator; preparing a negative electrode; producing an electrode assembly by stacking the positive electrode, the separator, and the negative electrode such that the positive electrode, the separator, and the negative electrode are arranged in this order; and housing the electrode assembly and the nonaqueous electrolyte in a case, in which the preparing the negative electrode includes: forming a first layer containing a metal of gold, platinum, or a combination thereof directly or indirectly on the separator side of a negative substrate; forming a second layer containing lithium ion conductivity polymer and a lithium salt and capable of restricting passage of the nonaqueous electrolyte on the separator side of the first layer; and forming a lithium metal layer between the negative substrate and the first layer. The method for manufacturing an energy storage device may further include bringing the case into a state of being pressed in a thickness direction of the electrode assembly. According to the method for manufacturing an energy storage device, the above-described energy storage device can be manufactured. That is, it is possible to manufacture an energy storage device in which the growth of dendrite is suppressed.

### (Preparation of Positive Electrode)

As the preparation of the positive electrode, the above-described positive electrode is used.

### (Preparation of Separator)

As the preparation of the separator, the above-described separator is used.

### (Preparation of Negative Electrode)

As the preparation of the negative electrode, a first layer containing a metal (non-lithium metal) of gold, platinum, or a combination thereof is formed directly or indirectly on the separator side of the negative substrate, a second layer containing a lithium ion conductive polymer and a lithium salt and capable of regulating the passage of the nonaqueous electrolyte is formed on the separator side of the first layer, and a lithium metal layer is formed between the negative substrate and the first layer.

Examples of forming the first layer on the separator side of the negative substrate include performing sputtering, vapor deposition, plating, coating, or the like directly or indirectly on a surface of the negative substrate with a material for forming the first layer containing the non-lithium metal as a main component, and among these, it is preferable to sputter the material for forming the first layer from the viewpoint of forming a denser layer.

By forming the second layer on the separator side of the first layer, a material for forming the second layer containing the lithium conductive polymer as a main component and containing a lithium salt can be applied onto the first layer formed on the negative substrate. The material for forming the second layer is prepared as a forming material by, for example, dissolving the lithium conductive polymer and the lithium salt in a solvent. Examples of the solvent include DMSO.

The lithium ion conductive polymer can be obtained as follows. That is, for example, a polymerization initiator such as a radical reaction initiator such as azobisisobutyronitrile (AIBN) is added to a solution obtained by mixing a carbonate-based monomer such as VC, a nitrile-based monomer such as AN, or a combination thereof and optionally a monomer other than the carbonate-based monomer and the nitrile-based monomer with a solvent such as N, N-dimethylformamide (DMF) at room temperature or while heating as necessary for rapidity or the like, and the mixture is allowed to stand overnight in a thermostatic chamber at a predetermined temperature according to the types of the monomer and the polymerization initiator, thereby polymerizing the monomer to obtain a product. A purified lithium ion conductive polymer can be obtained by washing the obtained product by a known method, recrystallization, or the like.

In applying the material for forming the second layer to the separator side of the first layer, for example, first, droplets of the material for forming the second layer are applied to the surface of the first layer on the separator side so that an amount of drops per unit area is the same. Next, by performing natural drying and reduced pressure drying, the second layer is formed by being stacked on the surface of the first layer on the separator side. Examples of the method of applying the material for forming the second layer include spraying by spraying, coating by a dip coater, coating by a spin coater, and coating by a roll coater.

When the negative electrode further includes the first lithium metal layer disposed between the first layer and the separator, more preferably between the first layer and the second layer, the first lithium metal layer can be formed between the first layer and the second layer by precipitation of lithium metal accompanying charge of the energy storage device.

The lithium metal layer can be formed between the negative substrate and the first layer by, for example, cutting a lithium metal foil as the second lithium metal layer into a predetermined shape or molding the lithium metal foil into a predetermined shape, pressing the negative substrate and the lithium metal foil, and then forming the first layer on the separator side of the lithium metal foil.

### (Fabrication of Electrode Assembly)

As the fabrication of the electrode assembly, for example, the positive electrode, the separator, and the negative electrode can be stacked so as to be arranged in this order, or wound in a stacked manner. When the separator has the substrate layer and the inorganic material layer, in producing the electrode assembly, the positive electrode, the separator, and the negative electrode can be overlapped or wound in a stacked manner so as to be arranged in this order and so that the inorganic material layer of the separator faces the negative electrode.

### (Housing in Case)

Housing the electrode assembly and the nonaqueous electrolyte in the case can be appropriately selected from known methods. For example, in the case of using a nonaqueous electrolyte solution for the nonaqueous electrolyte, the electrode assembly is housed in the case, and the nonaqueous electrolyte solution may be injected from an inlet formed in the case, followed by sealing the inlet. The details of the respective other elements configuring the energy storage device obtained by the manufacturing method are as described above.

### (Pressing of Electrode Assembly)

Examples of bringing the electrode assembly into the state of being pressed in the thickness direction thereof include restraining the case with a restraining member (not illustrated) or the like so as to bring the electrode assembly into the state of being pressed in the thickness direction thereof.

As described above, in the energy storage device of the present embodiment, the growth of dendrite is suppressed. In the method for manufacturing an energy storage device of the present embodiment, it is possible to manufacture an energy storage device in which the growth of dendrite is suppressed. In the energy storage apparatus of the present embodiment, the growth of dendrite is suppressed.

### Other Embodiments

It is to be noted that the energy storage device according to the present invention is not to be considered limited to the embodiment mentioned above, and various changes may be made without departing from the scope of the present invention. For example, to the configuration of one embodiment, the configuration of another embodiment can be added, and a part of the configuration of one embodiment can be replaced by the configuration of another embodiment or a well-known technique. Furthermore, a part of the configuration according to one embodiment can be deleted. In addition, a well-known technique can be added to the configuration according to one embodiment.

In the above embodiment, although the case where the energy storage device is used as a nonaqueous electrolyte secondary battery (for example, lithium secondary battery) that can be charged and discharged has been described, the type, shape, size, capacity, and the like of the energy storage device are arbitrary. The present invention can also be applied to various secondary batteries, and capacitors such as electric double layer capacitors and lithium ion capacitors.

In FIGS. 1 to 2 of the above embodiment, an aspect in which the separator includes the substrate layer and the inorganic material layer has been shown; however, in addition, for example, the separator may include only the substrate layer.

### EXAMPLES

Hereinafter, the present invention will be described more specifically with reference to examples. The present invention is not limited to the following Examples.

### Test Examples 1 to 6

### Production of Layered Product of Test Example 1

As a negative substrate on which the second lithium metal layer was stacked, a disk-shaped copper-lithium metal layered product (manufactured by Honjo Metal Co., Ltd.) having a diameter of 20 mm, in which a lithium metal plate having an average thickness of 60 μm was stacked on a copper foil having an average thickness of 10 μm, was prepared.

MAGNETRON SPUTTERING DEVICE (JUC-5000) manufactured by JEOL was used as a sputtering apparatus, and gold (Au) with a purity of 99.99% was used as a target. The height from a surface of the lithium metal plate to the target in the copper-lithium metal layered product was set to 25 mm, the current was set to 10 mA, and gold was sputtered on a surface of the layered product on a side where the lithium metal plate was stacked. The sputtering was performed once for 5 minutes, and performed three times in total. All the above operations were performed in a dry room. The average thickness of the first layer containing gold as the metal formed by the sputtering was 50 nm. In this way, a layered product of Test Example 1 was obtained.

### Production of Layered Products of Test Examples 2 and 3

Except that a metal shown in Table 1 was used as a target, the same procedure as in Test Example 1 was carried out to obtain layered products of Test Examples 2 and 3 in which a copper foil, a lithium metal plate, and the first layer formed of the metal shown in Table 1 were stacked in this order.

### Production of Metal Foils of Test Examples 4 to 6

As the metal foils of Test Examples 4 to 6, the metal foil shown in Table 1 was cut into a disk shape with a diameter of 20 mm and used. In Test Example 4, the copper-lithium metal layered product prepared in Test Example 1 was used.

### Evaluation of Affinity and Wettability of First Layer in Layered Products of Test Examples 1 to 3 and Metal Foils of Test Examples 4 to 6

Using the layered products and metal foils of Test Examples 1 to 6 obtained as described above, the contact angle of the reference solution and the degree of spread of the reference solution (maximum diameter of droplets) were measured by the measurement method described above as the evaluation of the affinity and wettability of the metal contained in the first layer in the layered products of Test Examples 1 to 3 and the metal foils (corresponding to the first layer) of Test Examples 4 to 6. The results are shown in Table 1.

### Example 1

### (Fabrication of Negative Electrode)

Similarly to Test Example 1, as the negative substrate on which the second lithium metal layer was stacked, a copper-lithium metal layered product in which a lithium metal plate having an average thickness of 60 μm as the second lithium metal layer was stacked on a copper foil having an average thickness of 10 μm as the negative substrate was prepared. The first layer was stacked on a surface of the copper-lithium metal layered product on a side where the lithium metal plate was stacked by sputtering gold (Au) similarly to Test Example 1. The obtained first layer had an average thickness of 50 nm.

The second layer was formed on a surface of the obtained first layer by the following procedure. 0.06 g of azobisisobutyronitrile (AIBN), which was a radical reaction initiator, was added to a solution obtained by mixing 10 g of VC with 2 mL of N, N-dimethylformamide (DMF), and the mixture was allowed to stand overnight in a thermostatic chamber at 60° C. to synthesize a product containing PVC. To the obtained product was added 20 mL of DMF, and the product was redissolved in DMF by stirring while heating at 60° C. Although it was possible to dissolve the product in DMF at room temperature, heating was performed as described above in consideration of the rapidity of the operation. The resulting solution was added dropwise little by little into 1 L of ethanol stirring at 350 rpm to recrystallize the product. The supernatant ethanol was removed from the product, and then the product was washed with ethanol several times to remove impurities. The finally obtained product was filtered through a Buchner funnel and allowed to stand overnight in a thermostatic chamber at 60° C. to obtain purified PVC as a lithium ion conductive polymer.

Next, the PVC obtained above and LiDFP as a lithium salt were dissolved in DMSO to prepare a lithium ion conductive polymer solution as a material for forming the second layer. The content of PVC in this forming material was set to 20% by mass, and the content of LiDFP was set to 0.6% by mass. That is, the content of LiDFP with respect to 100 parts by mass of PVC was set to 3 parts by mass. That is, the content (blending amount 1) of PVC with respect to the total content of PVC and LiDFP was set to 97% by mass, and the content (blending amount 2) of LiDFP was set to 3% by mass. The obtained forming material was applied onto the first layer obtained above using a dip coating method so that the amount of drops per unit area was the same, and natural drying and reduced-pressure drying were performed. The obtained second layer had an average thickness of 1.0 μm.

The negative electrode thus obtained had a strip shape with a width of 32 mm and a length of 42 mm.

### (Fabrication of Positive Electrode)

As a positive active material, a lithium-transition metal composite oxide, which had an α-NaFeO₂-type crystal structure and was represented by Li_{1+α}Me_{1-α}O₂ (Me was a transition metal), was used. In this regard, the molar ratio Li/Me of Li to Me was 1.33, and Me was composed of Ni and Mn and was contained at a molar ratio of Ni:Mn=0.33:0.67.

Next, a positive electrode paste, which contained the positive active material, acetylene black (AB) as a conductive agent, polyvinylidene fluoride (PVDF) as a binder, and phosphonic acid at a mass ratio of 92.25:4.5:3.0:0.25, was prepared using N-methylpyrrolidone (NMP) as a dispersion medium. The positive electrode paste was applied to one surface of an aluminum foil with an average thickness of 15 μm as a positive substrate, and dried, and the resultant was pressed to fabricate a positive electrode in which the positive active material layer was disposed. A coating amount of the positive active material layer was 26.5 mg/cm², and the porosity was 40%. The fabricated positive electrode had a strip shape with a width of 30 mm and a length of 40 mm.

### (Preparation of Nonaqueous Electrolyte)

As the nonaqueous solvent, FEC and DMC were used. Then, LiPF₆ was dissolved at a concentration of 1 mol/dm³ in a mixed solvent mixed at a volume ratio of FEC:DMC=30:70, and 1,3-propene proton (PRS) as an additive was further mixed with that solution at a content of 2% by mass to obtain a nonaqueous electrolyte.

### (Fabrication of Energy Storage Device)

As the separator, a separator in which an inorganic material layer containing aluminosilicate particles as an inorganic material was stacked on one surface of a polypropylene microporous membrane as a substrate layer was used. The average thickness of the separator was 21 μm, the average thickness of the substrate layer was 15 μm, and the average thickness of the inorganic material layer was 6 μm. The separator was disposed such that the inorganic material layer faced the negative electrode, and the positive electrode and the negative electrode were stacked with the separator interposed therebetween to produce an electrode assembly. The electrode assembly was housed in a case, then the nonaqueous electrolyte was injected into the inside of the case, and then an opening of the case was sealed by heat sealing to obtain an energy storage device according to Example 1 as a single-layer pouched cell.

### Example 2

An energy storage device of Example 2 was obtained similarly to Example 1 except that the average thickness of the second layer was 3.0 μm.

### Comparative Example 1

An energy storage device of Comparative Example 1 was obtained similarly to Example 1 except that a negative electrode was fabricated without forming the second layer on the first layer.

### Comparative Example 2

An energy storage device of Comparative Example 2 was obtained similarly to Example 1 except that the first layer was formed by sputtering tin (Sn) instead of gold, and a negative electrode was fabricated without forming the second layer on the formed first layer. The first layer had an average thickness of 50 nm.

### Comparative Example 3

An energy storage device of Comparative Example 3 was obtained similarly to Example 1 except that a copper-lithium metal layered product similar to that in Example 1 as a negative substrate on which the second lithium metal layer was stacked was used as a negative electrode without forming any first layer or any second layer on the lithium metal plate.

### (Initial Charge-Discharge 1)

The obtained energy storage devices were initially charged and discharged for 2 cycles at 25° C. under the following conditions. The charge was constant current constant voltage (CCCV) charge at a charge current of 0.1 C and a charge voltage of 4.6 V, and with regard to the end-of-charge condition, charge was performed until the charge current reached 0.05 C. The discharge was constant current (CC) discharge at a discharge current of 0.1 C and an end-of-discharge voltage of 2.0 V. A rest period of 10 minutes was provided after each of the charge and the discharge. Here, 1 C was set to 6.0 mA/cm² in terms of a current per unit area of the positive electrode.

### (Charge-Discharge Cycle Test 1)

Each energy storage device subjected to the initial charge-discharge 1 was subjected to a charge-discharge cycle test for 10 cycles at 25° C. under the following conditions. The charge was constant current constant voltage (CCCV) charge at a charge current of 0.2 C and a charge voltage of 4.6 V, and with regard to the end-of-charge condition, charge was performed until the charge current reached 0.05 C. The discharge was constant current (CC) discharge at a discharge current of 0.1 C and an end-of-discharge voltage of 2.0 V. A rest period of 10 minutes was provided after each of the charge and the discharge. 1 C is the same as that in the initial charge-discharge 1.

(Measurement of Average Thickness of Dendrite of Lithium Metal Precipitated after Charge-Discharge Cycle Test 1)

The average thickness of dendrite of lithium metal precipitated after the charge-discharge cycle test 1 in Example 1, Example 2, and Comparative Examples 1 to 3 was measured as follows. That is, the energy storage device after discharge at 10-th cycle in the charge-discharge cycle test 1 was disassembled, the thickness of the entire negative electrode was measured at arbitrary five points using a micrometer, and the average value was calculated. The total of the average thicknesses of the above-described negative substrate (10 μm), second lithium metal layer (60 μm), first layer (50 nm), and second layer (1.0 μm and 3.0 μm) was subtracted from the obtained average thickness of the entire negative electrode to obtain the average thickness of dendrite. In charge and discharge of about 10 cycles, the thickness of each layer of the negative electrode hardly changes, and since the first lithium metal layer hardly exists in the discharged state, the average thickness is an average length of dendrite in the stacking direction of the positive electrode, the separator, and the negative electrode. In addition, the average thickness is an index of the ease of occurrence of short circuit and the amount of electrically isolated dendrite, and indicates that the larger the average length, the more easily the short circuit occurs, and the larger the amount of electrically isolated dendrite, whereas the smaller the average length, the less easily the short circuit occurs, and the smaller the amount of electrically isolated dendrite.

TABLE 1

Evaluation of wettability

| | | Contact angle | Maximum diameter |
|---|---|---|---|
| | Metal | [°] | of droplet [mm] |
| Test Example 1 | Au | 10 | 6.8 |
| Test Example 2 | Sn | 30 | 6.6 |
| Test Example 3 | Pt | 18 | 7.1 |
| Test Example 4 | Li | 54 | 5.2 |
| Test Example 5 | Cu | 57 | 5.0 |
| Test Example 6 | Al | 56 | 5.4 |

TABLE 2

| | | | | | Second layer | | |
|---|---|---|---|---|---|---|---|
| | Negative active material | | | | Lithium ion | | |
| | | Thickness of | First layer | | conductive polymer | | |
| | | second lithium | | Average | | Blending | |
| | | metal layer | | thickness | | amount 1 | Lithium salt |
| | Metal | [μm] | Metal | [nm] | Type | [mass %] | Type |
| Example 1 | Li | 60 | Au | 50 | PVC | 97 | LiDFP |
| Example 2 | Li | 60 | Au | 50 | PVC | 97 | LiDFP |
| Comparative | Li | 60 | Au | 50 | — | — | — |
| Example 1 | | | | | | | |
| Comparative | Li | 60 | Sn | 50 | — | — | — |
| Example 2 | | | | | | | |
| Comparative | Li | 60 | — | — | — | — | — |
| Example 3 | | | | | | | |

| | Second layer | | | | |
|---|---|---|---|---|---|
| | | Blending | | | |
| | | amount of | | | |
| | | lithium salt | | | Average |
| | | when blending | | | thickness of |
| | Lithium salt | amount 1 is | | | Li dendrite |
| | Blending | 100 parts by | Average | | after 10 |
| | amount 2 | mass | thickness | | cycles |
| | [mass %] | [parts by mass] | [μm] | Separator | [μm] |
| Example 1 | 3 | 3 | 1.0 | Substrate layer/ | 22 |
| | | | | inorganic | |
| | | | | material layer | |
| Example 2 | 3 | 3 | 3.0 | Substrate layer/ | 25 |
| | | | | inorganic | |
| | | | | material layer | |
| Comparative | — | — | — | Substrate layer/ | 28 |
| Example 1 | | | | inorganic | |
| | | | | material layer | |
| Comparative | — | — | — | Substrate layer/ | 32 |
| Example 2 | | | | inorganic | |
| | | | | material layer | |
| Comparative | — | — | — | Substrate layer/ | 30 |
| Example 3 | | | | inorganic | |
| | | | | material layer | |

As shown in Table 1, since gold and platinum have a smaller contact angle of the reference solution and a high degree of spread of the reference solution than other metals in Table 1, the affinity for lithium metal and the wettability for the lithium ion conductive polymer solution are high, and therefore it is shown that the first layer containing these non-lithium metals has a relatively high affinity for lithium metal and a relatively high affinity for the second layer. As shown in Table 2, it was shown that in Example 1 and Example 2 including the first layer and the second layer, the growth of dendrite was suppressed as compared with Comparative Examples 1 to 3 not including at least one of the first layer and the second layer. In addition, it was shown that the growth of dendrite was further suppressed when the non-lithium metal contained in the first layer had higher wettability to the lithium ion conductive polymer solution than the lithium metal.

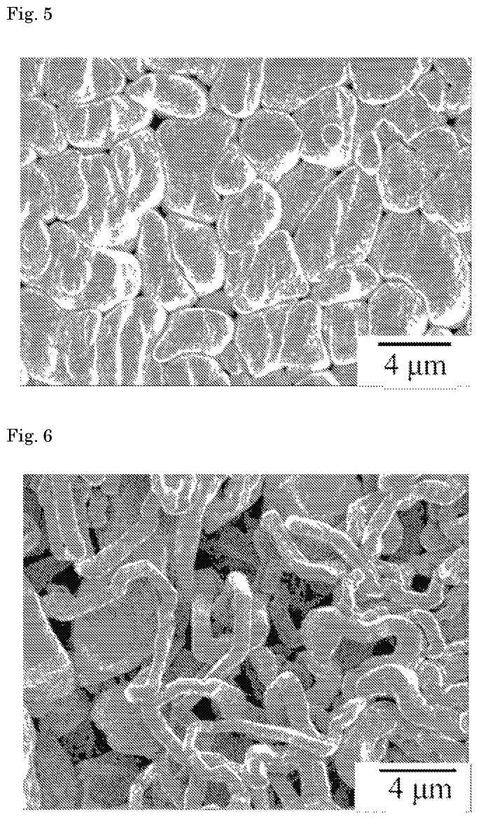

As a reference, the influence of the first layer on the crystal shape of the lithium metal to be precipitated was examined. FIG. 5 illustrates an image obtained by observing the crystal shape of lithium metal precipitated on the first layer in the negative electrode after initial charge in the initial charge-discharge 1 in Comparative Example 1 with a field emission scanning electron microscope (FE-SEM) from a direction perpendicular to the first layer. Similarly to the above, FIG. 6 illustrates an image obtained by observing the crystal shape of lithium metal precipitated on the second lithium metal layer in the negative electrode after initial charge in the initial charge-discharge 1 of Comparative Example 3 by FE-SEM from a direction perpendicular to the second lithium metal layer. As shown in FIG. 5, when the negative electrode included the first layer, the particulate lithium metal crystals formed a dense and smooth layer. On the other hand, as shown in FIG. 6, in Comparative Example 3 not including the first layer, a large amount of dendrite was precipitated.

As described above, the shape of the lithium metal crystal precipitated at the time of initial charge contributes to the suppression of the growth of dendrite. The reason is not necessarily clear, but is presumed as follows, for example. That is, when relatively smooth lithium metal crystal is generated at the time of initial charge due to the presence of the first layer, a contact area between the smooth lithium metal (see FIG. 5) and the nonaqueous electrolyte is smaller than a contact area between the non-smooth lithium metal (see FIG. 6) and the nonaqueous electrolyte, and therefore, it is presumed that the growth (average thickness) of dendrite is reduced in the subsequent charge-discharge cycle.

### Reference Example 1

An energy storage device of Reference Example 1 was produced similarly to Example 1 except that tin (Sn) was sputtered on the surface of the second lithium metal layer in the formation of the first layer similarly to Test Example 2, the average thickness of the second layer was set as shown in Table 3 in the formation of the second layer, and TFEMC was used instead of DMC in the preparation of the nonaqueous electrolyte.

### Reference Example 2

An energy storage device of Reference Example 2 was produced similarly to Reference Example 1 except that polypropylene carbonate (PPC) was synthesized using PC in place of VC in the formation of the second layer, the synthesized PPC was used, and the average thickness of the second layer was set as shown in Table 4.

### (Initial Charge-Discharge 2)

With respect to the obtained energy storage devices of Reference Examples 1 and 2 and Comparative Examples 2 and 3 described above, the initial charge-discharge was performed similarly to the initial charge-discharge 1 except that the coating amount of the positive active material layer was 32.0 mg/cm² and 1 C was 7.2 mA/cm² in terms of the current per unit area of the positive electrode.

### (Charge-Discharge Cycle Test 2)

A charge-discharge cycle test was performed on each energy storage device after the initial charge-discharge 2 similarly to the charge-discharge cycle test 1 except that 1 C was set to 7.2 mA/cm² in terms of the current per unit area of the positive electrode.

(Measurement of Average Thickness of Dendrite of Lithium Metal Precipitated after Charge-Discharge Cycle Test 2)

Similarly to the measurement of the average thickness of dendrite described above, the average thickness of dendrite of lithium metal precipitated after the charge-discharge cycle test 2 in Reference Examples 1 and 2 and Comparative Examples 2 and 3 was measured. The results are shown in Table 3.

TABLE 3

| | | | | | Second layer | | |
|---|---|---|---|---|---|---|---|
| | Negative active material | | | | Lithium ion | | |
| | | Thickness of | First layer | | conductive polymer | | |
| | | second lithium | | Average | | Blending | |
| | | metal layer | | thickness | | amount 1 | Lithium salt |
| | Metal | [μm] | Metal | [nm] | Type | [mass %] | Type |
| Reference | Li | 60 | Sn | 50 | PVC | 97 | LiDFP |
| Example 1 | | | | | | | |
| Reference | Li | 60 | Sn | 50 | PPC | 97 | LiDFP |
| Example 2 | | | | | | | |
| Comparative | Li | 60 | Sn | 50 | — | — | — |
| Example 2 | | | | | | | |
| Comparative | Li | 60 | — | — | — | — | — |
| Example 3 | | | | | | | |

| | Second layer | | | | |
|---|---|---|---|---|---|
| | | Blending | | | |
| | | amount of | | | |
| | | lithium salt | | | Average |
| | | when blending | | | thickness of |
| | Lithium salt | amount 1 is | | | Li dendrite |
| | Blending | 100 parts by | Average | | after 10 |
| | amount 2 | mass | thickness | | cycles |
| | [mass %] | [parts by mass] | [μm] | Separator | [μm] |
| Reference | 3 | 3 | 0.7 | Substrate layer/ | 48 |
| Example 1 | | | | inorganic | |
| | | | | material layer | |
| Reference | 3 | 3 | 4.5 | Substrate layer/ | 68 |
| Example 2 | | | | inorganic | |
| | | | | material layer | |
| Comparative | — | — | — | Substrate layer/ | 75 |
| Example 2 | | | | inorganic | |
| | | | | material layer | |
| Comparative | — | — | — | Substrate layer/ | 98 |
| Example 3 | | | | inorganic | |
| | | | | material layer | |

As shown in Table 3, it was shown that in Reference Examples 1 and 2 including the first layer and the second layer, the growth of dendrite was suppressed as compared with Comparative Examples 2 and 3 not including at least one of the first layer and the second layer.

### Example 3

In the formation of the second layer, polyacrylonitrile (PAN, average molecular weight: 150,000, manufactured by Aldrich) was used in place of PVC, LiTFSI was used as a lithium salt, and PAN and LiTFSI were dissolved in DMSO. Specifically, 10 mL of DMSO was mixed per 1 g of PAN to dissolve the PAN in DMSO. A material for forming the second layer was prepared by dissolving LiTFSI in the obtained solution. The content of PAN in this forming material was set to 10% by mass, and the content of LiTFSI was set to 1% by mass. That is, the content of LiTFSI with respect to 100 parts by mass of PAN was set to 10 parts by mass. That is, the content (blending amount 1) of PAN with respect to the total content of PAN and LiTFSI was set to 91% by mass, and the content (blending amount 2) of LiTFSI was set to 9% by mass. An energy storage device of Example 3 was produced using the forming material thus obtained similarly to Example 1 except that the average thickness of the second layer was set as shown in Table 4.

### Example 4

An energy storage device of Example 4 was produced similarly to Example 3 except that the content of PAN and the content of LiTFSI in the forming material were set to 10% by mass and 2.5% by mass, respectively (that is, the content of LiTFSI with respect to 100 parts by mass of PAN was set to 25 parts by mass). That is, in Example 4, the content (blending amount 1) of PAN with respect to the total content of PAN and LiTFSI was set to 80% by mass, and the content (blending amount 2) of LiTFSI was set to 20% by mass.

### Example 5

An energy storage device of Example 5 was produced similarly to Example 3 except that the content of PAN and the content of LiTFSI in the forming material were set to 10% by mass and 5% by mass, respectively (that is, the content of LiTFSI with respect to 100 parts by mass of PAN was set to 50 parts by mass), and the average thickness of the second layer was set as shown in Table 4. That is, in Example 5, the content (blending amount 1) of PAN with respect to the total content of PAN and LiTFSI was set to 67% by mass, and the content (blending amount 2) of LiTFSI was set to 33% by mass. The blending amount 1 and the blending amount 2 of Example 5 are rounded off to the first decimal place.

### Example 6

An energy storage device of Example 6 was produced similarly to Example 3 except that the content of PAN and the content of LiTFSI in the forming material were set to 10% by mass and 10% by mass, respectively (that is, the content of LiTFSI with respect to 100 parts by mass of PAN was set to 100 parts by mass), and the average thickness of the second layer was set as shown in Table 4. That is, in Example 6, the content (blending amount 1) of PAN with respect to the total content of PAN and LiTFSI was set to 50% by mass, and the content (blending amount 2) of LiTFSI was set to 50% by mass.

### Example 7

An energy storage device of Example 7 was produced similarly to Example 3 except that the content of PAN and the content of LiTFSI in the forming material were set to 10% by mass and 20% by mass, respectively (that is, the content of LiTFSI with respect to 100 parts by mass of PAN was set to 200 parts by mass), and the average thickness of the second layer was set as shown in Table 4. That is, in Example 7, the content (blending amount 1) of PAN with respect to the total content of PAN and LiTFSI was set to 33% by mass, and the content (blending amount 2) of LiTFSI was set to 67% by mass. The blending amount 1 and the blending amount 2 of Example 7 are rounded off to the first decimal place.

### Comparative Example 4

An energy storage device of Comparative Example 4 was produced similarly to Example 3 except that LiTFSI was not used as a forming material and the average thickness of the second layer was set as shown in Table 4.

### (Initial Charge-Discharge 3)

With respect to the obtained energy storage devices of Example 3 to Example 7 and Comparative Example 4, the initial charge-discharge was performed similarly to the initial charge-discharge 1.

### (Charge-Discharge Cycle Test 3)

For each energy storage device after the initial charge-discharge 3, the charge-discharge cycle test was performed similarly to the charge-discharge cycle test 1.

(Measurement of Average Thickness of Dendrite of Lithium Precipitated after Charge-Discharge Cycle Test 3)

Similarly to the measurement of the average thickness of dendrite described above, the average thickness of dendrite of lithium precipitated after the charge-discharge cycle test 3 in Examples 3 to 7 and Comparative Example 4 was measured. The results are shown in Table 4. Table 4 also shows the results of Comparative Examples 1 and 3 and Example 1 described above.

TABLE 4

| | | | | | Second layer | | |
|---|---|---|---|---|---|---|---|
| | Negative active material | | | | Lithium ion | | |
| | | Thickness of | First layer | | conductive polymer | | |
| | | second lithium | | Average | | Blending | |
| | | metal layer | | thickness | | amount 1 | Lithium salt |
| | Metal | [μm] | Metal | [nm] | Type | [mass %] | Type |
| Example 3 | Li | 60 | Au | 50 | PAN | 91 | LiTFSI |
| Example 4 | Li | 60 | Au | 50 | PAN | 80 | LiTFSI |
| Example 5 | Li | 60 | Au | 50 | PAN | 67 | LiTFSI |
| Example 6 | Li | 60 | Au | 50 | PAN | 50 | LiTFSI |
| Example 7 | Li | 60 | Au | 50 | PAN | 33 | LiTFSI |
| Comparative | Li | 60 | Au | 50 | PAN | 100 | — |
| Example 4 | | | | | | | |
| Comparative | Li | 60 | Au | 50 | — | — | — |
| Example 1 | | | | | | | |
| Comparative | Li | 80 | — | — | — | — | — |
| Example 3 | | | | | | | |
| Example 1 | Li | 60 | Au | 50 | PVC | 97 | LiDFP |

| | Second layer | | | | |
|---|---|---|---|---|---|
| | | Blending | | | |
| | | amount of | | | |
| | | lithium salt | | | Average |
| | | when blending | | | thickness of |
| | Lithium salt | amount 1 is | | | Li dendrite |
| | Blending | 100 parts by | Average | | after 10 |
| | amount 2 | mass | thickness | | cycles |
| | [mass %] | [parts by mass] | [μm] | Separator | [μm] |
| Example 3 | 9 | 10 | 2.0 | Substrate layer/ | 27 |
| | | | | inorganic | |
| | | | | material layer | |
| Example 4 | 20 | 25 | 2.0 | Substrate layer/ | 22 |
| | | | | inorganic | |
| | | | | material layer | |
| Example 5 | 33 | 50 | 2.5 | Substrate layer/ | 19 |
| | | | | inorganic | |
| | | | | material layer | |
| Example 6 | 50 | 100 | 3.0 | Substrate layer/ | 21 |
| | | | | inorganic | |
| | | | | material layer | |
| Example 7 | 67 | 200 | 4.0 | Substrate layer/ | 21 |
| | | | | inorganic | |
| | | | | material layer | |
| Comparative | — | — | 1.5 | Substrate layer/ | 40 |
| Example 4 | | | | inorganic | |
| | | | | material layer | |
| Comparative | — | — | — | Substrate layer/ | 28 |
| Example 1 | | | | inorganic | |
| | | | | material layer | |
| Comparative | — | — | — | Substrate layer/ | 30 |
| Example 3 | | | | inorganic | |
| | | | | material layer | |
| Example 1 | 3 | 3 | 1.0 | Substrate layer/ | 22 |
| | | | | inorganic | |
| | | | | material layer | |

As shown in Table 4, it was shown that even when the second layer contained a PAN-based lithium ion conductive polymer, in Examples 3 to 7 including the first layer and the second layer, the growth of dendrite was suppressed as compared with Comparative Examples 1 to 3 not including at least one of the first layer and the second layer. Further, it was shown that in Examples 3 to 7 including the second layer containing a lithium salt, the growth of dendrite was suppressed as compared with Comparative Example 4 including the second layer not containing a lithium salt. Furthermore, as shown in Examples 3 to 5, it was shown that when the content of the lithium salt was smaller than the content of PAN, the growth of dendrite tended to be suppressed as the content of the lithium salt was larger. The reason for this is not necessarily clear, but it is presumed that the growth of dendrite is suppressed as a result of improving the lithium ion conductivity of the second layer by containing a PAN-based lithium ion conductive polymer and a lithium salt. Comparison between Example 3 and Example 1 showed that the growth of dendrite was suppressed even when the content of the lithium salt was small in Example 1 including the second layer containing a PVC-based lithium ion conductive polymer than in Example 3 including the second layer containing a PAN-based lithium ion conductive polymer. In view of this result and the fact that a PVC-based lithium ion conductive polymer is less likely to cause the nonaqueous electrolyte to swell than a PAN-based lithium ion conductive polymer as described later, it is sufficiently and rationally inferred that dendrite is more suppressed when the second layer contains a lithium salt than when the second layer does not contain the lithium salt even in an energy storage device including the second layer containing the PVC-based lithium ion conductive polymer.

### Test Example 7

A forming material was prepared similarly to Comparative Example 4 described above, and the obtained forming material was applied onto a glass substrate using a doctor blade method, naturally dried and vacuum-dried, and then punched into a disk shape having a diameter of 20 mm to form a second layer for a nonaqueous electrolyte swelling test of Test Example 7. The average thickness of the second layer was set as shown in Table 5. The obtained second layer of Test Example 7 was subjected to a nonaqueous electrolyte swelling test.

### Test Examples 8 to 12

A second layer for a nonaqueous electrolyte swelling test of Test Example 8 was formed similarly to Test Example 7 except that a forming material prepared similarly to Example 3 described above was used and the average thickness was set as shown in Table 5. A second layer for a nonaqueous electrolyte swelling test of Test Example 9 was formed similarly to Test Example 7 except that a forming material prepared similarly to Example 4 described above was used and the average thickness was set as shown in Table 5. A second layer for a nonaqueous electrolyte swelling test of Test Example 10 was formed similarly to Test Example 7 except that a forming material prepared similarly to Example 5 described above was used and the average thickness was set as shown in Table 5. A second layer for a nonaqueous electrolyte swelling test of Test Example 11 was formed similarly to Test Example 7 except that a forming material prepared similarly to Example 6 described above was used and the average thickness was set as shown in Table 5. A second layer for a nonaqueous electrolyte swelling test of Test Example 12 was formed similarly to Test Example 7 except that a forming material prepared similarly to Example 7 described above was used and the average thickness was set as shown in Table 5. The obtained second layers of Test Examples 8 to 12 were subjected to the nonaqueous electrolyte swelling test.

### Test Example 13

A forming material was prepared similarly to Example 3 except that LiDFP was used as the lithium salt instead of LiTFSI. A second layer for a nonaqueous electrolyte swelling test of Test Example 13 was formed similarly to Test Example 7 except that that forming material was used and the average thickness was set as shown in Table 5. The obtained second layer of Test Example 13 was subjected to a nonaqueous electrolyte swelling test.

### Test Example 14

A forming material was prepared similarly to Example 4 except that LiDFP was used as the lithium salt instead of LiTFSI. A second layer for a nonaqueous electrolyte swelling test of Test Example 14 was formed similarly to Test Example 7 except that that forming material was used and the average thickness was set as shown in Table 5. The obtained second layer of Test Example 14 was subjected to a nonaqueous electrolyte swelling test.

### Test Example 15

A second layer for a nonaqueous electrolyte swelling test of Test Example 15 was formed similarly to Test Example 7 except that a forming material prepared similarly to Example 1 described above was used and the average thickness was set as shown in Table 5. The obtained second layer of Test Example 15 was subjected to a nonaqueous electrolyte swelling test.

### (Nonaqueous Electrolyte Swelling Test)

### (1) Preparation of Test Nonaqueous Electrolyte

As the nonaqueous solvent, FEC and DMC were used. Then, LiPF₆ was dissolved at a concentration of 1 mol/dm³ in a mixed solvent mixed at a volume ratio of FEC:DMC=30:70, and PRS as an additive was further mixed with that solution at a content of 2% by mass to prepare a test nonaqueous electrolyte.

### (2) Evaluation of Degree of Swelling

The obtained second layers of Test Examples 7 to 15 were subjected to the nonaqueous electrolyte swelling test as follows. First, a mass A (g) of the obtained second layer before swelling of the nonaqueous electrolyte was measured, then 0.2 mL of the test nonaqueous electrolyte was added dropwise to the second layer, and the resulting mixture was allowed to stand in a sealed case for 24 hours to swell the nonaqueous electrolyte to the second layer. After the standing, the second layer was taken out from the sealed case, and an excess nonaqueous electrolyte adhering to a surface of the taken out second layer was removed so as not to affect the measurement result, and then a mass B (g) of the second layer after swelling of the nonaqueous electrolyte was measured. Then, as shown in the following Formula 1, a mass increase amount (g) of the second layer by the nonaqueous electrolyte swelling test was calculated by subtracting the mass A before swelling of the nonaqueous electrolyte from the mass B after swelling of the nonaqueous electrolyte. In addition, the degree of swelling of the nonaqueous electrolyte (% by mass) of the second layer was calculated by calculating a ratio (percentage) of the mass B after swelling of the nonaqueous electrolyte to the mass A before swelling of the nonaqueous electrolyte as shown in the following Formula 2. The results are shown in Table 5.

$$Mass increase amount ( g ) of second layer = mass B \cdot mass A \qquad 1$$

$$2$$

$$Degree of swelling of nonaqueous electrolyte of second layer ( mass \% ) = ( mass B / mass A ) \times 100$$

TABLE 5

| | | | | | | | | | Mass | |
|---|---|---|---|---|---|---|---|---|---|---|
| | Second layer for nonaqueous electrolyte swelling test | | | | | | | | increase | |
| | | | | | Blending | | | | amount of | |
| | | | | | amount of | | Mass A of | Mass B of | second layer | Degree of |
| | | | | | lithium salt | | second layer | second layer | after | swelling of |
| | Lithium ion | | | | when blending | | before | after | nonaqueous | nonaqueous |
| | conductive polymer | | Lithium salt | | amount 1 is | | nonaqueous | nonaqueous | electrolyte | electrolyte |
| | | Blending | | Blending | 100 parts by | Average | electrolyte | electrolyte | swelling | of second |
| | | amount 1 | | amount 2 | mass | thickness | swelling test | swelling test | test * 1 | layer * 2 |
| | Type | [mass %] | Type | [mass %] | [parts by mass] | [μm] | [g] | [g] | [g] | [mass %] |
| Test | PAN | 100 | — | — | — | 30.0 | 0.0106 | 0.0108 | 0.0002 | 102 |
| Example 7 | | | | | | | | | | |
| Test | PAN | 0 | LiTFSI | 0 | 10 | 27.0 | 0.0100 | 0.0113 | 0.0013 | 113 |
| Example 8 | | | | | | | | | | |
| Test | PAN | 0 | LiTFSI | 0 | 25 | 29.0 | 0.0104 | 0.0119 | 0.0015 | 114 |
| Example 9 | | | | | | | | | | |
| Test | PAN | 0 | LiTFSI | 0 | 50 | 27.0 | 0.0086 | 0.0104 | 0.0018 | 121 |
| Example 10 | | | | | | | | | | |
| Test | PAN | 0 | LiTFSI | 0 | 100 | 81.0 | 0.0270 | 0.0293 | 0.0023 | 109 |
| Example 11 | | | | | | | | | | |
| Test | PAN | 0 | LiTFSI | 0 | 200 | 294.0 | 0.0846 | 0.0892 | 0.0046 | 105 |
| Example 12 | | | | | | | | | | |
| Test | PAN | 0 | LiDFP | 0 | 10 | 25.0 | 0.0087 | 0.0097 | 0.0010 | 111 |
| Example 13 | | | | | | | | | | |
| Test | PAN | 0 | LiDFP | 0 | 25 | 24.0 | 0.0086 | 0.0098 | 0.0012 | 114 |
| Example 14 | | | | | | | | | | |
| Test | PVC | 97 | LiDFP | 3 | 3 | 2.0 | 0.0040 | 0.0053 | 0.0013 | 133 |
| Example 15 | | | | | | | | | | |

* 1 Mass increase amount (g) = mass B − mass A
* 2 Degree of swelling of nonaqueous electrolyte (mass %) = (mass B/mass A) × 100

As shown in Table 5, it was shown that in the second layer containing PAN, the nonaqueous electrolyte tended to be less likely to swell as compared with the second layer containing PVC. In the second layer containing PAN, as in Test Examples 8 to 10, when the content of the lithium salt was smaller than the content of PAN, the swelling amount of the nonaqueous electrolyte tended to increase as the content of the lithium salt increased. In general, it is considered that dendrite is more likely to be generated as the swelling amount of the nonaqueous electrolyte increases. However, as is clear from the results of Tables 4 and 5 described above, in the second layer containing PAN, when the content of the lithium salt is small as compared with the content of PAN, the swelling amount of the nonaqueous electrolyte becomes relatively large as the content of the lithium salt is relatively large; however, the generation of dendrite tends to be reduced as compared with the second layer in which the content of the lithium salt is relatively small. The reason for this is not necessarily clear, but it is presumed that the second layer containing PAN is a layer in which while the swelling amount of the nonaqueous electrolyte is relatively small as compared with the second layer containing PVC, the lithium ion conductivity is relatively small, and such relatively small lithium ion conductivity is improved by the lithium salt.

As a result, it was shown that in the energy storage device, the growth of dendrite was suppressed.

### INDUSTRIAL APPLICABILITY

The present invention is suitable for various power sources such as a power source for an automobile such as a personal computer, an electric vehicle (EV), a hybrid vehicle (HEV), or a plug-in hybrid vehicle (PHEV), a power source for a flight vehicle such as an airplane or a drone, a power source for an electronic device such as a personal computer or a communication terminal, and a power source for power storage. In particular, the energy storage device is particularly suitable as a power source for a flight vehicle, because the device has both an extremely high gravimetric energy density required particularly for a power source for a flight vehicle and adequate charge-discharge cycle performance.

### DESCRIPTION OF REFERENCE SIGNS

1: Energy storage device
2: Electrode assembly
3: Case
4: Positive electrode terminal
41: Positive electrode lead
5: Negative electrode terminal
51: Negative electrode lead
6: Positive electrode
7: Positive substrate
8: Positive active material layer
9: Separator
10: Substrate layer
11: Inorganic material layer
12: Negative electrode
13: Negative substrate
14: First layer
15: Second layer
16: First lithium metal layer
17: Second lithium metal layer
20: Energy storage unit
30: Energy storage apparatus

1. An energy storage device comprising:
an electrode assembly including a positive electrode, a negative electrode, and a separator; and
a nonaqueous electrolyte,
wherein the negative electrode includes a negative substrate, a first layer disposed directly or indirectly on the separator side of the negative substrate and containing a metal of gold, platinum, or a combination thereof, and a second layer disposed on the separator side of the first layer, containing a polymer having lithium ion conductivity and a lithium salt, and regulating passage of the nonaqueous electrolyte, and the negative electrode further includes a lithium metal layer disposed between the negative substrate and the first layer.

2. The energy storage device according to claim 1, wherein the polymer contained in the second layer includes a polymer material containing vinylene carbonate, acrylonitrile, or a combination thereof as a monomer.

3. The energy storage device according to claim 1, wherein the negative electrode further includes a lithium metal layer disposed between the first layer and the separator.

4. The energy storage device according to claim 1, wherein the separator includes a substrate layer and an inorganic material layer disposed on the negative electrode side of the substrate layer.

5. The energy storage device according to claim 1, wherein the lithium salt is lithium difluorophosphate, lithium difluoro(oxalato)borate, lithium bis(trifluoromethanesulfonyl)imide, or a combination thereof.

6. The energy storage device according to claim 1, wherein the electrode assembly is in a state of being pressed in a thickness direction thereof.

7. A method for manufacturing an energy storage device comprising:
preparing a positive electrode;
preparing a separator;
preparing a negative electrode; and
producing an electrode assembly by stacking the positive electrode, the separator, and the negative electrode such that the positive electrode, the separator, and the negative electrode are arranged in this order,
wherein the preparing the negative electrode includes forming a first layer containing a metal of gold, platinum, or a combination thereof directly or indirectly on the separator side of a negative substrate, forming a second layer containing a polymer having lithium ion conductivity and a lithium salt and restricting passage of the nonaqueous electrolyte on the separator side of the first layer, and forming a lithium metal layer between the negative substrate and the first layer.

8. An energy storage apparatus comprising:
one or a plurality of energy storage devices according to claim 1; and
a restraining member that restrains the one or the plurality of energy storage devices, wherein
the one or the plurality of energy storage devices are pressed in a thickness direction of the electrode assembly by the restraining by the restraining member, whereby the electrode assembly is pressed.
